(19) United States
(12) Patent Application Publication
(10) Pub. No.: US 2026/0353193 A1
(43) Pub. Date: Nov. 5, 2026

(54) ELECTRONIC DEVICE AND METHOD OF PERFORMING NON-PRIMARY CHANNEL ACCESS

(71) Applicant: SAMSUNG ELECTRONICS CO., LTD., Suwon-si (KR)

(72) Inventor: Junsu CHOI, Suwon-si (KR)

(73) Assignee: SAMSUNG ELECTRONICS CO., LTD., Suwon-si (KR)

(21) Appl. No.: 19/415,197

(22) Filed: Dec. 10, 2025

Related U.S. Application Data
(63) Continuation of application No. PCT/KR2025/018828, filed on Nov. 14, 2025.

(30) Foreign Application Priority Data
Apr. 30, 2025 (KR) 10-2025-0057377
Jun. 2, 2025 (KR) 10-2025-0072164

(51) Int. Cl. H04W 28/18; H04L 5/00; H04W 72/30

(52) U.S. Cl. CPC H04W 28/18; H04L 5/0048; H04W 72/30

(57) ABSTRACT

An electronic device includes wireless communication circuitry, at least one processor including processing circuitry, and memory storing instructions that, when executed by the at least one processor individually or collectively, cause the electronic device to transmit to an access point (AP), through the wireless communication circuitry, a first request frame requesting communication via a first secondary channel, receive from the AP, through the wireless communication circuitry, a first response frame requesting communication via a second secondary channel, perform negotiation with the AP, based on at least one of the first information or the second information, to determine a target SP that is common in the first BSS and the second BSS, and broadcast information on the target SP to the first BSS.

### CROSS-REFERENCE TO RELATED APPLICATIONS

This application is a continuation application of International Application No. PCT/KR2025/018828 designating the United States, filed on Nov. 14, 2025, in the Korean Intellectual Property Receiving Office and claiming priority to Korean Patent Application No. 10-2025-0057377, filed on Apr. 30, 2025, and Korean Patent Application No. 10-2025-0072164, filed on Jun. 2, 2025, in the Korean Intellectual Property Office, the disclosures of which are incorporated by reference herein in their entireties.

### BACKGROUND

### 1. Field

The present disclosure relates to an electronic device and a method of performing non-primary channel access (NPCA).

### 2. DESCRIPTION OF RELATED ART

Wireless-Fidelity (Wi-Fi) deployments may have increased with emergence of mobile devices such as, but not limited to, laptops, smartphones, and tablets. Recently, Wi-Fi may be used in several areas of daily life. The increased use of Wi-Fi may also have increased demand for relatively faster wireless networks. As a result, Wi-Fi technologies may have evolved from a previous generation to a subsequent generation of the Wi-Fi networks. For example, a recent Wi-Fi technology that may have been standardized and/or commercialized may be referred to as Wi-Fi 6 (e.g., a sixth generation of Wi-Fi), and standardization for a next-generation technology standard, which may be referred to as Wi-Fi 7, may be currently in development by a task group.

Future generations of Wi-Fi (e.g., Wi-Fi 8) may include and/or implement various technologies that may improve the efficiency of a Wi-Fi network and/or may provide predictable and/or definitive service qualities to each user of the network, even in various congested situations.

The above information may be presented as a related art to help with the understanding of the present disclosure. No arguments or decisions are raised as to whether any of the above description is applicable as prior art related to the present disclosure.

### SUMMARY

According to an aspect of the present disclosure, an electronic device includes wireless communication circuitry. The electronic device includes at least one processor including processing circuitry. The electronic device includes memory storing instructions. The instructions, when executed by the at least one processor individually or collectively, cause the electronic device to transmit to an access point (AP), through the wireless communication circuitry, a first request frame requesting communication via a first secondary channel. The instructions, when executed by the at least one processor individually or collectively, cause the electronic device to receive from the AP, through the wireless communication circuitry, a first response frame requesting communication via a second secondary channel. The instructions, when executed by the at least one processor individually or collectively, cause the electronic device to perform negotiation with the AP, based on at least one of the first information or the second information, to determine a target SP that is common in the first BSS and the second BSS. The instructions, when executed by the at least one processor individually or collectively, cause the electronic device to broadcast information on the target SP to the first BSS. The first request frame includes first information on a first service period (SP). A first primary channel of a first basic service set (BSS) formed by the electronic device at least partially overlaps a second primary channel of a second BSS formed by the AP. The first response frame includes second information on a second SP.

According to an aspect of the present disclosure, an electronic device includes wireless communication circuitry. The electronic device includes at least one processor including processing circuitry. The electronic device includes memory storing instructions. The instructions, when executed by the at least one processor individually or collectively, cause the electronic device to provide, using the wireless communication circuitry, network access to one or more wireless communication devices via a primary channel of a first BSS. The instructions, when executed by the at least one processor individually or collectively, cause the electronic device to generate first information on one or more first secondary channels corresponding to the first BSS and second information on a first SP based on a first request to use the one or more first secondary channels in the first BSS. The instructions, when executed by the at least one processor individually or collectively, cause the electronic device to obtain, using the wireless communication circuitry, third information on one or more second secondary channels corresponding to a second BSS and fourth information on a second SP based on a second request to use the one or more second secondary channels in the second BSS, from at least one of an external AP included in the second BSS or another device coupled with the external AP. The instructions, when executed by the at least one processor individually or collectively, cause the electronic device to determine at least a first portion of one of the one or more first secondary channels as a third secondary channel and at least a second portion of the first SP as a third SP, based at least in part on the first information, the second information, the third information, or the fourth information. The instructions, when executed by the at least one processor individually or collectively, cause the electronic device to provide the network access via the third secondary channel and prevent the network access via the primary channel during the third SP. The first BSS includes the electronic device and the one or more wireless communication devices.

According to an aspect of the present disclosure, an operating method of an electronic device includes transmitting, to an AP, a first request frame requesting communication via a first secondary channel. The operating method includes receiving, from the AP, a first response frame requesting communication via a second secondary channel. The operating method includes performing negotiation with the AP based on at least one of the first information or the second information to determine a target SP that is common in the first BSS and the second BSS. The operating method includes broadcasting information on the target SP to the first BSS. The first request frame includes first information on a first service period (SP). The first response frame includes second information on a second SP. A first primary channel of a first BSS formed by the electronic device at least partially overlaps a second primary channel of a second BSS formed by the the AP.

According to an embodiment, a non-transitory computer-readable storage medium may store instructions that, when executed by a processor, cause the processor to perform the operating method.

Additional aspects may be set forth in part in the description which follows and, in part, may be apparent from the description, and/or may be learned by practice of the presented embodiments.

### BRIEF DESCRIPTION OF THE DRAWINGS

The above and other aspects, features, and advantages of certain embodiments of the present disclosure will be more apparent from the following detailed description, taken in conjunction with the accompanying drawings, in which:

FIGS. 1 and 2 are diagrams illustrating a wireless local area network (WLAN) system, according to an embodiment;

FIG. 3 is a diagram illustrating a link setup operation, according to an embodiment;

FIG. 4 is a schematic block diagram illustrating an access point (AP), according to an embodiment;

FIG. 5 is a schematic block diagram illustrating a station (STA), according to an embodiment;

FIG. 6 is a diagram illustrating a frequency band and a bandwidth, which are used in a WLAN system, according to an embodiment;

FIG. 7 is a diagram illustrating a primary channel and a secondary channel in a WLAN system, according to an embodiment;

FIGS. 8A and 8B are diagrams illustrating frequency resource utilization, according to an embodiment;

FIG. 9 is a diagram illustrating an example of a communication environment in which signal interference may occur due to constraints of a primary channel and/or a secondary channel, according to an embodiment;

FIG. 10 is a diagram illustrating a non-primary channel access (NPCA) negotiation method based on multi-AP cooperation, according to an embodiment;

FIGS. 11A and 11B are diagrams illustrating various examples of a multi-AP cooperation system, according to an embodiment.

FIG. 12 is a diagram illustrating an operation of negotiating NPCA between APs, according to an embodiment;

FIG. 13 is a diagram illustrating an NPCA negotiation result, according to an embodiment;

FIG. 14 is a diagram illustrating an example of information on a service period (SP) that is requested to be communicated via a secondary channel;

FIG. 15 is a diagram illustrating an example of an NPCA negotiation process between APs through a command field, according to an embodiment;

FIG. 16 is a diagram illustrating a method of renegotiating NPCA, according to an embodiment;

FIG. 17A is a diagram illustrating a situation in which NPCA renegotiation is needed, according to an embodiment;

FIG. 17B is a diagram illustrating an NPCA renegotiation result, according to an embodiment;

FIG. 18 is a flowchart illustrating an operation of an electronic device, according to an embodiment;

FIG. 19 is a diagram illustrating an operation of triggering NPCA negotiation, according to an embodiment;

FIG. 20 is a diagram illustrating an NPCA negotiation method between three or more APs, according to an embodiment; and

FIG. 21 is a block diagram illustrating an electronic device in a network environment, according to an embodiment.

### DETAILED DESCRIPTION

The following description with reference to the accompanying drawings is provided to assist in a comprehensive understanding of embodiments of the present disclosure defined by the claims and their equivalents. Various specific details are included to assist in understanding, but these details are considered to be exemplary only. Therefore, those of ordinary skill in the art may recognize that various changes and modifications of the embodiments described herein may be made without departing from the scope and spirit of the disclosure. In addition, descriptions of well-known functions and structures are omitted for clarity and conciseness.

As used herein, when an element or layer is referred to as “covering”, “overlapping”, or “surrounding” another element or layer, the element or layer may cover at least a portion of the other element or layer, where the portion may include a fraction of the other element or may include an entirety of the other element. Similarly, when an element or layer is referred to as “penetrating” another element or layer, the element or layer may penetrate at least a portion of the other element or layer, where the portion may include a fraction of the other element or may include an entire dimension (e.g., length, width, depth) of the other element.

Reference throughout the present disclosure to “one embodiment,” “an embodiment,” “an example embodiment,” or similar language may indicate that a particular feature, structure, or characteristic described in connection with the indicated embodiment is included in at least one embodiment of the present solution. Thus, the phrases “in one embodiment”, “in an embodiment,” “in an example embodiment,” and similar language throughout this disclosure may, but do not necessarily, all refer to the same embodiment. The embodiments described herein are example embodiments, and thus, the disclosure is not limited thereto and may be realized in various other forms.

It is to be understood that the specific order or hierarchy of blocks in the processes/flowcharts disclosed are an illustration of exemplary approaches. Based upon design preferences, it is understood that the specific order or hierarchy of blocks in the processes/flowcharts may be rearranged. Further, some blocks may be combined or omitted. The accompanying claims present elements of the various blocks in a sample order, and are not meant to be limited to the specific order or hierarchy presented.

The embodiments herein may be described and illustrated in terms of blocks, as shown in the drawings, which carry out a described function or functions. These blocks, which may be referred to herein as units or modules or the like, or by names such as device, logic, circuit, controller, counter, comparator, generator, converter, or the like, may be physically implemented by analog and/or digital circuits including one or more of a logic gate, an integrated circuit, a microprocessor, a microcontroller, a memory circuit, a passive electronic component, an active electronic component, an optical component, and the like.

In the present disclosure, the articles “a” and “an” are intended to include one or more items, and may be used interchangeably with “one or more.” Where only one item is intended, the term “one” or similar language is used. For example, the term “a processor” may refer to either a single processor or multiple processors. When a processor is described as carrying out an operation and the processor is referred to perform an additional operation, the multiple operations may be executed by either a single processor or any one or a combination of multiple processors.

Hereinafter, various embodiments of the present disclosure are described with reference to the accompanying drawings. When describing the embodiments with reference to the accompanying drawings, like reference numerals refer to like elements and a repeated description related thereto may be omitted for the sake of brevity.

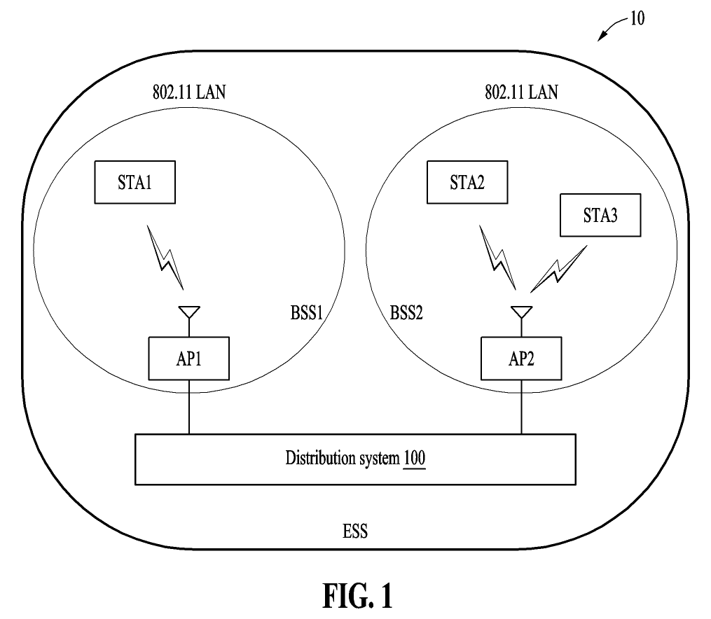

FIGS. 1 and 2 are diagrams illustrating a wireless local area network (WLAN) system, according to an embodiment.

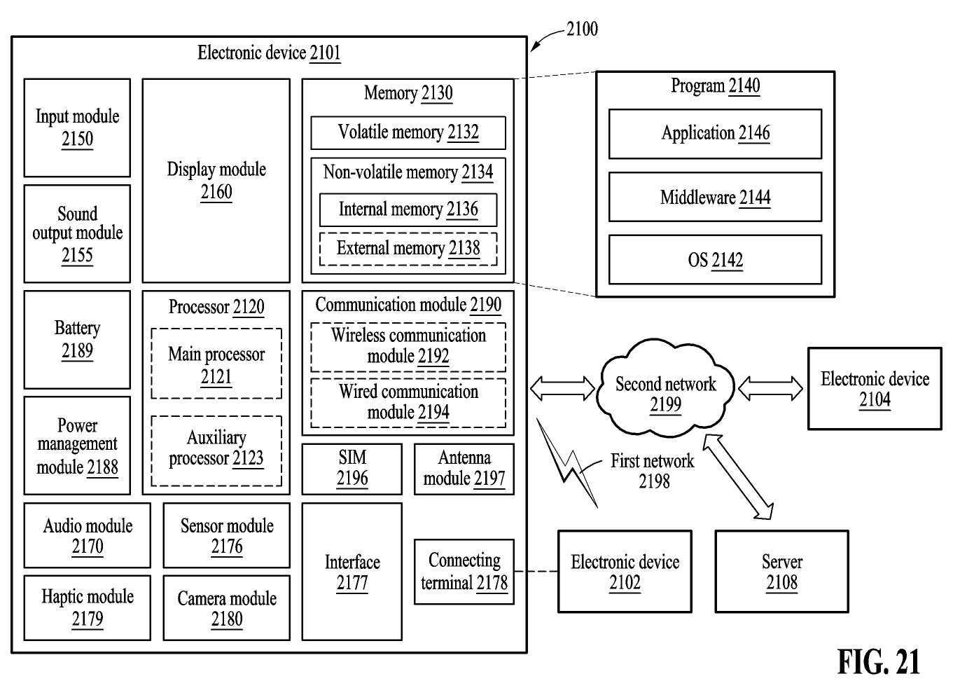

Referring to FIG. 1, according to an embodiment, a WLAN system 10 may refer to an infrastructure mode in which an access point (AP) is present in a structure of a WLAN according to a wireless telecommunication standard, such as, but not limited to, an Institute of Electrical and Electronic Engineers (IEEE) 802.11 standard. The WLAN system 10 may include one or more basic service sets (BSSs) (e.g., a first BSS BSS1 and a second BSS BSS2). The one or more BSS (e.g., the first BSS BSS1 or the second BSS BSS2) may refer to a set of APs and/or stations (STAs) (e.g., a first electronic device 2101, a second electronic device 2102, and an external electronic device 2104 of FIG. 21) that may communicate with each other with successful synchronization. The first BSS BSS1 may include a first AP AP1 and a first STA STA1, and the second BSS BSS2 may include a second AP AP2, a second STA STA2, and a third STA STA3. However, embodiments of the present disclosure are not limited in this regard. That is the WLAN system 10 depicted in FIG. 1 may not be limited to the number of BSSs, the number of APs, and/or the number of STAs shown in the figure. In actual implementation, the WLAN system 10 may include additional BSSs (e.g., more than two (2)), additional APs (e.g., more than two (2)), and/or additional STAs (e.g., more than three (3)) without departing from the scope of the present disclosure.

According to an embodiment, the WLAN system 10 may include at least one STA (e.g., the first STA STA1 to the third STA STA3), a plurality of APs (e.g., the first AP AP1 and the second AP AP2) providing a distribution service, and a distribution system 100 connecting the plurality of APs (e.g., the first AP AP1 and the second AP AP2). The distribution system 100 may implement an extended service set (ESS), which may be a service set extended by connecting a plurality of BSSs (e.g., the first BSS BSS1 and the second BSS BSS2). The ESS may refer to one network in which the plurality of APs (e.g., the first AP AP1 and the second AP AP2) are connected through the distribution system 100. In an embodiment, the plurality of APs (e.g., the first AP AP1 and the second AP AP2) included in one ESS may have the same service set identification (SSID).

According to an embodiment, the at least one STA (e.g., the first STA STA1 to the third STA STA3) may be an arbitrary functional medium including a medium access control (MAC) and a physical layer interface for a wireless medium that may conform to the provisions of one or more wireless telecommunication standards, such as, but not limited to, an IEEE 802.11 standard. The term STA (e.g., the first STA STA1 to the third STA STA3) may collectively refer to both an AP and a non-AP STA. The at least one STA (e.g., the first STA STA1 to the third STA STA3) may also be referred to by various names, such as, but not limited to, an electronic device, a mobile terminal, a wireless device, a wireless transmit/receive unit (WTRU), user equipment (UE), a mobile station (MS), a mobile subscriber unit, or a user.

Referring to FIG. 2, according to an embodiment, a WLAN system 20 may refer to an ad-hoc mode in which a network is established and communicated between a plurality of STAs (e.g., the first STA STA1 to the third STA STA3) without any AP in a structure of a WLAN of a wireless telecommunication standard, such as, but not limited to, an IEEE 802.11 standard. The WLAN system 20 may include a BSS operating in an ad-hoc mode, for example, an independent basic service set (IBSS).

According to an embodiment, the IBSS may not include an AP, and as such, may not include a centralized management entity that may perform a central management function for the STAs in the system. That is, in the IBSS, the STAs may be managed in a distributed manner. For example, in the IBSS, all the STAs may be and/or may include mobile STAs that may form a self-contained network (or an integrated network) because access to a distribution system may not be allowed.

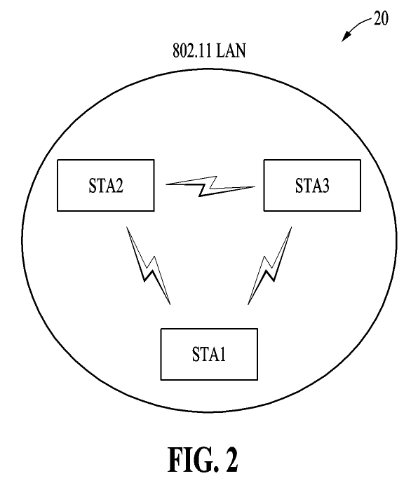

FIG. 3 is a diagram illustrating a link setup operation, according to an embodiment.

Referring to FIG. 3, according to an embodiment, the link setup operation may be performed between devices (e.g., an STA 301 and an AP 401) to communicate with each other. For the link setup, operations for network discovery, execution of authentication, establishing association, and setting security may be performed. The link setup operation may be referred to as a session initiation operation or a session setup operation. Furthermore, the operations of discovery, authentication, association, and setting security of the link setup operation may be collectively referred to as an association operation.

According to an embodiment, the network discovery operation may include operations 310 and 320. In operation 310, an STA 301 (e.g., the first electronic device 2101, the second electronic device 2102, or the external electronic device 2104 of FIG. 21) may transmit a probe request frame to probe which AP exists and may wait for a response to the probe request frame. The STA 301 may find a network to participate in by performing a scanning operation to access the network. The probe request frame may include information of the STA 301 (e.g., a device name and/or address of the STA 301). The scanning operation in operation 310 may refer to an active scanning operation. In operation 320, an AP 401 may transmit a probe response frame to the STA 301 that may transmit the probe request frame, in response to the probe request frame. The probe response frame may include information of the AP 401 (e.g., a device name and/or network information of the AP 401). Although FIG. 3 shows that the network discovery operation is performed through active scanning, embodiments of the present disclosure are not necessarily limited thereto. When the STA 301 performs passive scanning, the operation of transmitting the probe request frame may be omitted. The STA 301 that performs passive scanning may receive a beacon frame transmitted by the AP 401 and perform the following subsequent procedures.

According to an embodiment, after the STA 301 discovers a network, an authentication operation including operations 330 and 340 may be performed. In operation 330, the STA 301 may transmit an authentication request frame to the AP 401. In operation 340, the AP 401 may determine whether to allow authentication for the STA 301 based on information included in the authentication request frame. The AP 401 may provide the STA 301 with a result of authentication processing through an authentication response frame. The authentication frame used for the authentication request and/or response may correspond to a management frame.

According to an embodiment, the authentication frame may include information on an authentication algorithm number, an authentication transaction sequence number, status code, challenge text, a robust security network (RSN), or a finite cyclic group.

According to an embodiment, after successful authentication of the STA 301, an association operation including operations 350 and 360 may be performed. In operation 350, the STA 301 may transmit an association request frame to the AP 401. In operation 360, the AP 401 may transmit an association response frame to the STA 301 in response to the association request frame.

According to an embodiment, the association request frame and/or the association response frame may include information related to various capabilities. For example, the association request frame may include information related to various capabilities, a beacon listening interval, an SSID, supported rates, supported channels, an RSN, a mobility domain, supported operating classes, a traffic indication map (TIM) broadcast request, and/or information related to an interworking service capability. As another example, the association response frame may include information related to various capabilities, status code, association ID (AID), supported rates, an enhanced distributed channel access (EDCA) parameter set, a received channel power indicator (RCPI), a received signal-to-noise indicator (RSNI), a mobility domain, a timeout interval (e.g., an association comeback time), an overlapping BSS scan parameter, a TIM broadcast response, and/or information such as, but not limited to, a quality of service (QoS) map. However, embodiments of the present disclosure are not limited in this regard.

According to an embodiment, after the STA 301 is successfully associated with the network, a security setup operation including operations 370 and 380 may be performed. The security setup operation may be performed through a robust security network association (RSNA) request/response. For example, the security setup operation may include an operation of performing private key setup by means of a 4-way handshaking through an extensible authentication protocol over local area network (LAN) (EAPOL) frame. In an embodiment, the security setup operation may be performed according to a security scheme that may not be defined in a wireless telecommunications standard, such as, but not limited to, an IEEE 802.11 standard.

According to an embodiment, a security session may be established between the STA 301 and the AP 401 according to the security setup operation, and the STA 301 and the AP 401 may proceed with secure data communication.

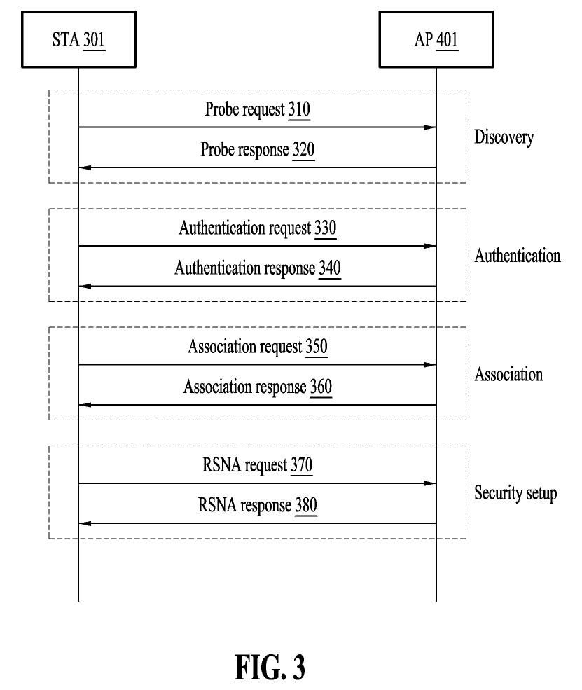

FIG. 4 is a schematic block diagram illustrating an AP, according to an embodiment.

Referring to FIG. 4, according to an embodiment, an electronic device 400 may be an example of the APs (e.g., the first AP AP1, the second AP AP2, and the AP 401) described with reference to FIGS. 1-3. That is, the electronic device 400 may include and/or may be similar in many respects to the APs described above with reference to FIGS. 1-3, and may include additional features not mentioned above. Consequently, repeated descriptions of the electronic device 400 described above with reference to FIGS. 1-3 may be omitted for the sake of brevity.

According to an embodiment, the electronic device 400 may include a processor 410, memory 420, a transmitter 440, a receiver 450, and an antenna portion 460. The transmitter 440 and the receiver 450 may be combined into a transceiver 490 (e.g., wireless communication circuitry).

According to an embodiment, the processor 410 may perform a MAC function, a physical layer (PHY) function, a radio frequency (RF) function, or a combination of all or a portion thereof. The processor 410 may include all or a portion of the transmitter 440 and the receiver 450. The processor 410 may be coupled to the memory 420. The coupling may be direct or indirect.

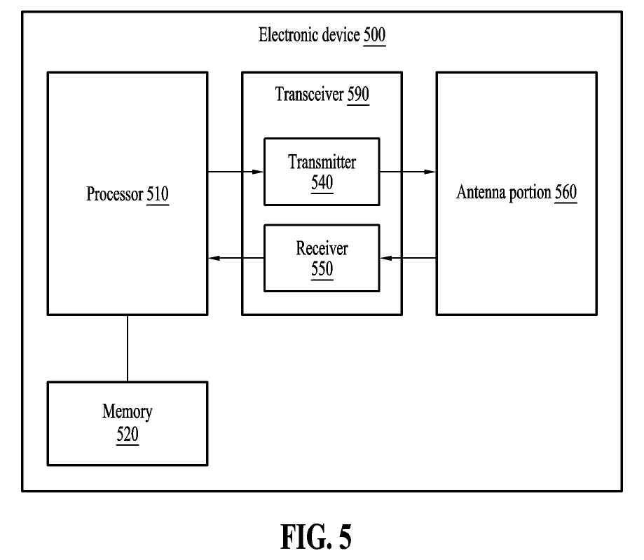

According to an embodiment, the processor 410 may be implemented as circuitry (e.g., processing circuitry) such as, but not limited to, a system-on-chip (SoC) or an integrated circuit (IC). The processor 410 may include one or more processors. For example, the processor 410 may include a combination of one or more processors, such as, but not limited to, a central processing unit (CPU), a graphics processing unit (GPU), a micro processing unit (MPU), an application processor (AP), and a communication processor (CP). The CP may be inside or outside the transceiver 490. Instructions stored in the memory 420 may be executed by one processor to cause the electronic device 400 to perform and/or control the operation of the electronic device (e.g., the AP 401) described with reference to FIGS. 1-3 and an operation of an electronic device (e.g., the AP 401) described with reference to FIGS. 6, 7, 8A, 8B, 9, 10, 11A, 11B, 12-16, 17A, 17B, and 18-21. The instructions stored in the memory 420 may be executed by a plurality of processors to cause the electronic device 400 to perform and/or control the operation of the electronic device (e.g., the AP 401) described with reference to FIGS. 1-3 and an operation of an electronic device (e.g., the AP 401) described with reference to FIGS. 6, 7, 8A, 8B, 9, 10, 11A, 11B, 12-16, 17A, 17B, and 18-21.

According to an embodiment, the memory 420 may be and/or may include a non-transitory storage medium that stores instructions that, when executed by the processor 410, may cause the electronic device 400 to perform the operations, methods, or procedures described herein. The memory 420 may store instructions required by one or more of the processor 410, the transmitter 440, the receiver 450, and other components of the electronic device 400. The memory 420 may further store an operating system and/or an application. The memory 420 may include, be implemented as, or be included in read-and-write memory, read-only memory, volatile memory, non-volatile memory, or a combination of all or a portion thereof.

According to an embodiment, the memory 420 may include one or more memories. The instructions stored in the memory 420 may be stored in one memory. The instructions stored in the memory 420 may be divided and stored in a plurality of memories. The instructions stored in the memory 420 may be executed by the processor 410 to cause the electronic device 400 to perform and/or control the operation of the electronic device (e.g., the AP 401) described with reference to FIGS. 1-3 and an operation of an electronic device (e.g., the AP 401) described with reference to FIGS. 6, 7, 8A, 8B, 9, 10, 11A, 11B, 12-16, 17A, 17B, and 18-21.

According to an embodiment, the antenna portion 460 may include one or more physical antennas. When multiple-input multiple-output (MIMO) or multi-user MIMO (MU-MIMO) is used, the antenna portion 460 may include one or more physical antennas.

According to an embodiment, the transceiver 490 may be and/or may include circuitry configured to transmit and receive a wireless signal. In an embodiment, the transceiver 490 may be and/or may include a wireless fidelity (Wi-Fi) chipset. The transceiver 490 may support multiple bands of 2.4 gigahertz (GHz), 5 GHz, and/or 6 GHz. However, embodiments of the present disclosure are not limited in this regard. The processor 410 may be operatively connected to the transceiver 490. The memory 420 may be electrically connected to the processor 410 and store one or more instructions executable by the processor 410. The electronic device 400 may correspond to an electronic device (e.g., the first electronic device 2101) described with reference to FIG. 21. Therefore, repeated descriptions to be provided with reference to FIG. 21 may be omitted for the sake of brevity. The operations performed by the electronic device 400 may include an operation performed by the transceiver 490 and an operation performed by the processor 410 through the transceiver 490.

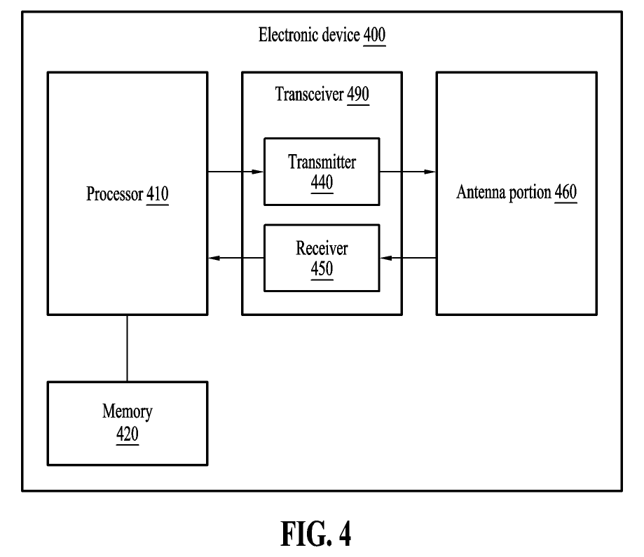

FIG. 5 is a schematic block diagram illustrating an STA, according to an embodiment.

Referring to FIG. 5, according to an embodiment, an electronic device 500 may be an example of the STAs (e.g., the first to third STAs STA1 to STA3 and the STA 301) described with reference to FIGS. 1-3. That is, the electronic device 500 may include and/or may be similar in many respects to the STAs described above with reference to FIGS. 1-3, and may include additional features not mentioned above. Consequently, repeated descriptions of the electronic device 500 described above with reference to FIGS. 1-3 may be omitted for the sake of brevity.

According to an embodiment, the electronic device 500 may include a processor 510, memory 520, a transmitter 540, a receiver 550, and an antenna portion 560. The transmitter 540 and the receiver 550 may be combined into a transceiver 590 (e.g., wireless communication circuitry).

According to an embodiment, the processor 510 may perform a MAC function, a PHY function, an RF function, or a combination of all or a portion thereof. The processor 510 may include all or a portion of the transmitter 540 and the receiver 550. The processor 510 may be coupled to the memory 520. The coupling may be direct or indirect.

According to an embodiment, the processor 510 may be implemented as circuitry (e.g., processing circuitry) such as, but not limited to, a SoC or an IC. The processor 510 may include one or more processors. For example, the processor 510 may include a combination of one or more processors, such as, but not limited to, a CPU, a GPU, an MPU, an AP, and a CP. The CP may be inside or outside the transceiver 590. Instructions stored in the memory 520 may be executed by one processor to cause the electronic device 500 to perform and/or control the operation of the electronic device (e.g., the STA 301) described with reference to FIGS. 1-3 and an operation of an electronic device (e.g., the STA 301) described with reference to FIGS. 6, 7, 8A, 8B, 9, 10, 11A, 11B, 12-16, 17A, 17B, and 18-21. The instructions stored in the memory 520 may be executed by a plurality of processors to cause the electronic device 500 to perform and/or control the operation of the electronic device (e.g., the STA 301) described with reference to FIGS. 1-3 and an operation of an electronic device (e.g., the STA 301) described with reference to FIGS. 6, 7, 8A, 8B, 9, 10, 11A, 11B, 12-16, 17A, 17B, and 18-21.

According to an embodiment, the memory 520 may be and/or may include a non-transitory storage medium that stores instructions that, when executed by the processor 510, cause the electronic device 500 to perform the operations, methods, or procedures described herein. The memory 520 may store instructions required by one or more of the processor 510, the transmitter 540, the receiver 550, and other components of the electronic device 500. The memory 520 may further store an operating system and an application. The memory 520 may include, be implemented as, or be included in read-and-write memory, read-only memory, volatile memory, non-volatile memory, or a combination of all or a portion thereof.

According to an embodiment, the memory 520 may include one or more memories. The instructions stored in the memory 520 may be stored in one memory. The instructions stored in the memory 520 may be divided and stored in a plurality of memories. The instructions stored in the memory 520 may be executed by the processor 510 to cause the electronic device 500 to perform and/or control the operation of the electronic device (e.g., the STA 301) described with reference to FIGS. 1-3 and an operation of an electronic device (e.g., the STA 301) described with reference to FIGS. 6, 7, 8A, 8B, 9, 10, 11A, 11B, 12-16, 17A, 17B, and 18-21.

According to an embodiment, the antenna portion 560 may include one or more physical antennas. When a MIMO or an MU-MIMO is used, the antenna portion 560 may include one or more physical antennas.

According to an embodiment, the transceiver 590 may be and/or may include circuitry configured to transmit and receive a wireless signal. The transceiver 590 may be a Wi-Fi chipset. The transceiver 590 may support multiple bands of 2.4 GHz, 5 GHz, and/or 6 GHz. However, embodiments of the present disclosure are not limited in this regard. The processor 510 may be operatively connected to the transceiver 590. The memory 520 may be electrically connected to the processor 510 and store one or more instructions executable by the processor 510. The operations performed by the electronic device 500 may include an operation performed by the transceiver 590 and an operation performed by the processor 510 through the transceiver 590.

FIG. 6 is a diagram illustrating a frequency band and a bandwidth, which are used in a WLAN system, according to an embodiment.

Referring to FIG. 6, in a WLAN system (or a Wi-Fi communication system) (e.g., the WLAN system 10 of FIG. 1 and/or the WLAN system 20 of FIG. 2), technology for transmitting data using a communication channel with a wide bandwidth may be used to increase the data transmission speed. In general, the wider the bandwidth for data transmission, the faster the transmission speed may be, but there may be cases in which a communication channel with a relatively narrow bandwidth may be used. For example, when a distance between an AP (e.g., the AP 401 of FIG. 3) and a client device (e.g., the STA 301 of FIG. 3) is relatively long, communication based on a wide bandwidth may not provide a sufficient signal-to-noise ratio (SNR). In another example, when the AP supports a wide bandwidth (e.g., 160 megahertz (MHz)), the maximum supported bandwidth (e.g., 80 MHz) of the client device may be narrower than the maximum supported bandwidth (e.g., 160 MHz) of the AP.

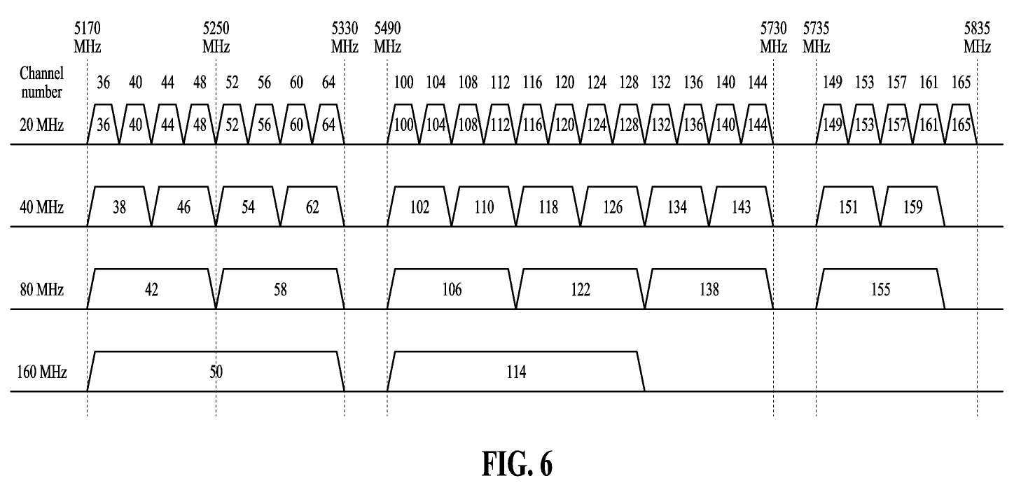

FIG. 7 is a diagram illustrating a primary channel and a secondary channel in a WLAN system, according to an embodiment.

Referring to FIG. 7, in a WLAN system (or a Wi-Fi communication system) (e.g., the WLAN system 10 of FIG. 1 and/or the WLAN system 20 of FIG. 2), a primary channel and a secondary channel may be concepts for channel bonding. Channel bonding may refer to a technology for providing a wide bandwidth. For example, a channel C3 with a bandwidth of 40 MHz may be formed by combining a primary channel C1 and a secondary channel C2, which each may have a bandwidth of 20 MHz.

In legacy WLAN communication (or Wi-Fi communication), when an AP (e.g., the AP 401 of FIG. 3) and a client device (e.g., the STA 301 of FIG. 3) exchange data using a bandwidth narrower than the maximum supported bandwidth of the AP, the AP and the client device may exchange data under the constraints of the primary channel and/or the secondary channel. For example, when the AP and the client device exchange data using a bandwidth of 80 MHz, which may be narrower than the maximum supported bandwidth of 160 MHz of the AP, constraints that a primary channel C4 with a bandwidth of 80 MHz should be used may be applied, instead of a secondary channel C5 with a bandwidth of 80 MHz. The same constraints may be applied when transmitting and/or receiving uplink (UL) orthogonal frequency division multiple access (OFDMA) and/or downlink (DL) OFDMA. However, these constraints may result in a frequency resource underutilization issue.

In the WLAN system, the frequency resources may need to be efficiently managed or allocated to improve communication performance or communication reliability.

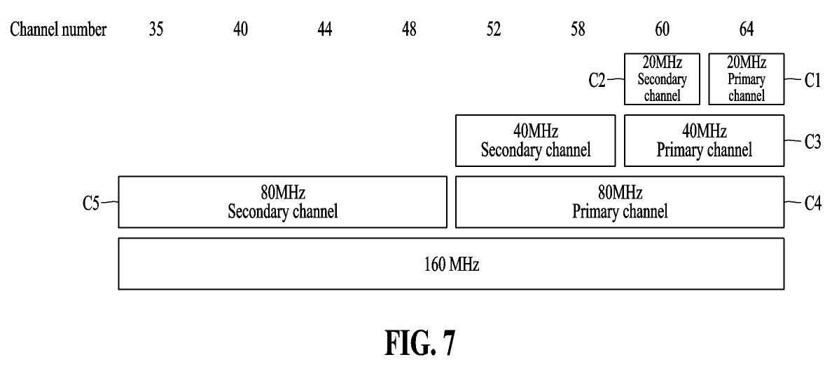

FIGS. 8A and 8B are diagrams illustrating frequency resource utilization, according to an embodiment.

FIG. 8A may be a diagram illustrating an example of a communication environment in which frequency resource underutilization may occur.

Referring to FIG. 8A, in legacy WLAN communication (or Wi-Fi communication), when each of a plurality of client devices (e.g., a first client device 820 and a second client device 822, which may be substantially similar to the STA 301 of FIG. 3) exchanges data with a first AP 810 using a bandwidth (e.g., 160 MHz) narrower than the maximum supported bandwidth (e.g., 320 MHz) of the first AP 810 (e.g., the AP 401 of FIG. 3), the first AP 810 or each of the plurality of client devices 820 and 822 may use a primary channel C61 between the primary channel C61 and a secondary channel C63 according to the constraints of a primary channel and/or a secondary channel. As the plurality of client devices 820 and 822 all transmit and/or receive data via the primary channel C61, the congestion of the primary channel C61 may increase and the frequency resource utilization may decrease.

FIG. 8B may be a diagram illustrating frequency resource underutilization in a high band.

Referring to FIG. 8B, recent generations of a Wi-Fi standard (e.g., Wi-Fi 6E or Wi-Fi 7) may provide technologies to utilize a band of 6 GHz. Since the bandwidth (e.g., 1,200 MHz) of a band of 6 GHz is wider than the bandwidth (e.g., 700 MHz) of a band of 5 GHz, the frequency resource underutilization due to the constraints of the primary channel and/or the secondary channel may become a bigger issue in a band of 6 GHz. For example, in a case in which a client device (e.g., the first client device 820 or the second client device 822 of FIG. 8A) that supports a bandwidth of 160 MHz is connected to an AP (e.g., the first AP 810 of FIG. 8A) that supports the maximum supported bandwidth (e.g., a bandwidth of 320 MHz), the client device (e.g., the first client device 820 or the second client device 822 of FIG. 8A) may transmit or receive data using a bandwidth of 160 MHz that is narrower than that of 320 MHz. In such a case, according to the constraints of the primary channel and/or the secondary channel, only three (3) frequency regions (e.g., second frequency region F2, fourth frequency region F4, and sixth frequency region F6) among the available frequency regions (e.g., a first frequency region F1 to a seventh frequency region F7) of a bandwidth of 160 MHz may be used.

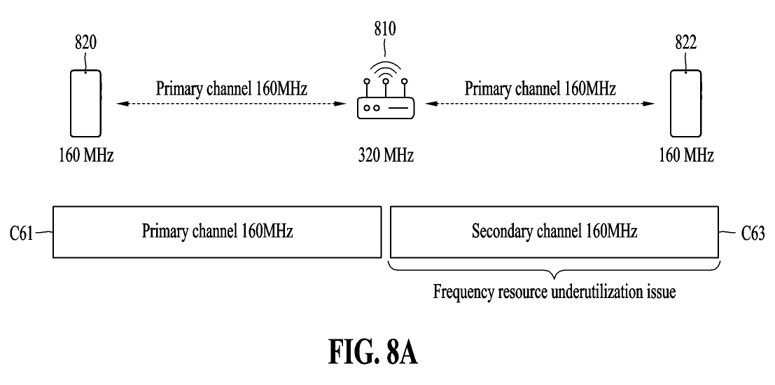

FIG. 9 is a diagram illustrating an example of a communication environment in which signal interference may occur due to constraints of a primary channel and/or a secondary channel.

Referring to FIG. 9, in a legacy WLAN system, while the first client device 820 exchanges data with the first AP 810 using the primary channel C61 of a bandwidth of 160 MHz, communication between the first client device 820 and the first AP 810 may be interfered with by another nearby electronic device (e.g., a second AP 910).

To address the frequency resource underutilization issue or the signal interference issue, technology for utilizing a secondary channel C62 may be needed. For example, non-primary channel access (NPCA) may be used. NPCA may refer to technology that may allow the first client device 820 and/or the first and second APs 810 and 910 to access a wireless channel via a secondary channel rather than a primary channel.

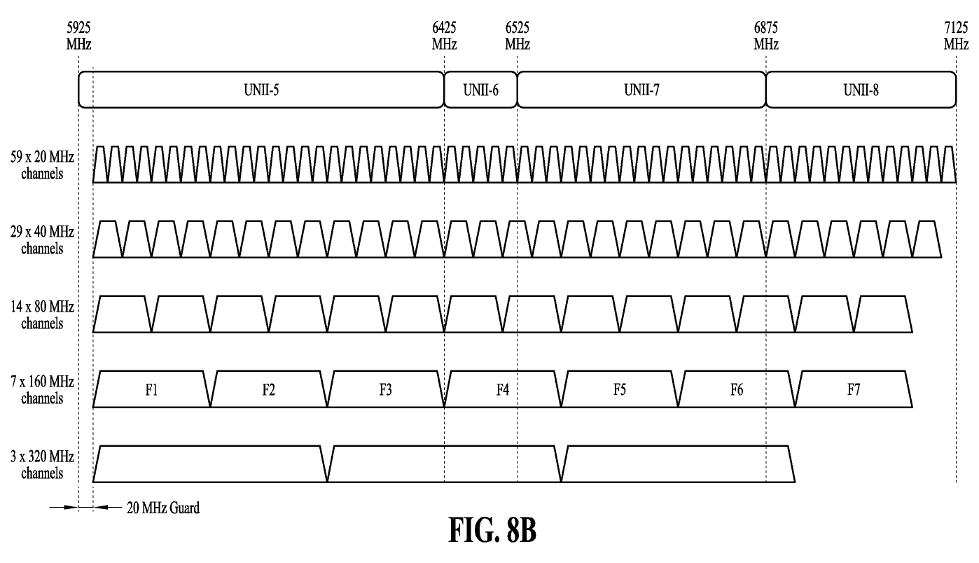

FIG. 10 is a diagram illustrating an NPCA negotiation method based on multi-AP cooperation, according to an embodiment.

Referring to FIG. 10, according to an embodiment, a first AP 1001 (e.g., the AP 401 of FIG. 3 and/or the first AP 810 of FIG. 9) and a second AP 1002 (e.g., the AP 401 of FIG. 3 and/or the second AP 910 of FIG. 9) may be adjacent to each other and form a coexisting environment (e.g., an overlapped basic service set (OBSS)). The first AP 1001 may form a first BSS, and the second AP 1002 may form a second BSS. The first AP 1001 and the second AP 1002 may share wireless resources, such as frequency resources, and may cause interference therebetween. For example, a primary channel (e.g., the maximum bandwidth including a primary channel) of the first BSS may at least partially overlap a primary channel of the second BSS.

Hereinafter, for ease of description, it may be assumed that the primary channel of the first BSS, which is formed by the first AP 1001, at least partially overlaps the primary channel of the second BSS, which is formed by the second AP 1002, and it may be premised that STAs included in the first BSS are referred to as first STAs, and STAs included in the second BSS are referred to as second STAs.

According to an embodiment, when the second STA occupies the primary channel, the first STA may not be able to access the primary channel occupied by the second STA, and thus, the first STA may not be able to access a wireless channel. That is, even when the primary channel occupied by the second STA is a partial bandwidth that is a portion of the maximum bandwidth, the first STA may not be able to access the wireless channel via the primary channel due to the frequency resource underutilization issue according to the constraints of the primary channel and/or secondary channel described above with reference to FIG. 8A. To address this issue, the first STA may perform NPCA and access the wireless channel via a secondary channel rather than the primary channel occupied by the second STA.

According to an embodiment, frame detection-based NPCA may be performed to access the wireless channel via the secondary channel. The first AP 1001 and the first STAs may negotiate in advance to communicate via a predetermined secondary channel when the primary channel is occupied by other electronic devices (e.g., the second AP 1002 and/or the second STAs). The first AP 1001 and the first STAs may negotiate in advance on a channel number (e.g., an index number or channel index number) and/or the maximum bandwidth (e.g., a bandwidth less than the maximum bandwidth of an operating channel including the primary channel) of a predetermined secondary channel.

Based on the result of negotiation, the first STAs may perform frame detection-based NPCA. The first STA may detect a frame (e.g., a frame transmitted and/or received by the second STA via the primary channel) of the second STA (and/or the second AP 1002) included in an adjacent BSS. The first STA may identify that the second STA is occupying the primary channel by detecting the frame of the second STA. The first STA may access, through frame detection of the second STA, the wireless channel via the secondary channel that is negotiated with the first AP 1001 in advance when the second STA is occupying the primary channel. As such, frame detection-based NPCA may be a method of accessing the wireless channel via a negotiated secondary channel based on the negotiation between the AP and the STA in advance and the detection of the frame by the electronic devices included in the OBSS.

However, frame detection-based NPCA may have limitations. For NPCA to be performed normally, contention and/or transmission and reception between electronic devices (e.g., the first AP 1001 and/or the first STAs) may need to be performed normally in a period (e.g., an NPCA service period (SP)) in which the secondary channel is used and/or other periods (e.g., primary channel access (PCA) SPs). To this end, all electronic devices in the first BSS may need to be synchronized and operated in time in the NPCA SP and other SPs (e.g., PCA SPs). In the case of frame detection-based NPCA, since the electronic devices in a doze (sleep) state may not be able to detect a frame of an adjacent BSS according to the traffic state of the electronic devices, synchronization may be difficult when changing the primary channel. For example, when at least a portion of the first STAs is in a doze state, at least a portion of the first STAs may not be able to detect a frame (e.g., a frame of the second AP 1002 included in the second BSS and/or the second STAs) of an adjacent BSS (e.g., a second BSS). In such a case, a problem in which all electronic devices in the first BSS are not synchronized may occur.

According to an embodiment, NPCA based on cooperation between APs may be performed to access the wireless channel via the secondary channel. NPCA based on cooperation between APs may negotiate an NPCA SP between APs (e.g., the first AP 1001 and/or the second AP 1002) and synchronize all electronic devices in the BSS by causing the STAs (e.g., the first STAs and/or the second STAs) to perform NPCA in a negotiated (or determined) SP (e.g., a target SP). NPCA based on cooperation between APs may cause the STAs (e.g., the first STAs and/or the second STAs) to perform NPCA, even when the STAs are not capable of detecting the frame of an adjacent BSS (e.g., in a doze state). Hereinafter, a method of negotiating (e.g., NPCA-negotiating) a target SP that is common in the first BSS and the second BSS by the first AP 1001 and the second AP 1002 is described. The target SP may refer to an SP in which all electronic devices (e.g., the first AP 1001 and/or the first STAs) in the first BSS and all electronic devices (e.g., the second AP 1002 and/or the second STAs) in the second BSS perform NPCA simultaneously.

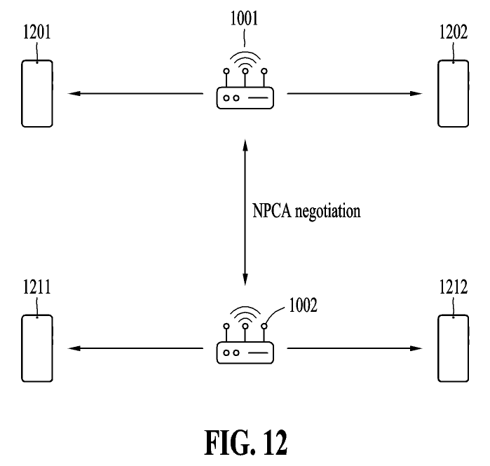

According to an embodiment, the first AP 1001 may transmit, to the second AP 1002, a request frame 1010 requesting to negotiate the NPCA SP. The request frame 1010 may include information (e.g., first information) on an SP (e.g., a first SP) that the first AP 1001 requests to communicate via the secondary channel (e.g., a first secondary channel). The information on the SP may include information on a secondary channel to be used in the SP, a start time of the SP, an interval of the SP, and a duration of the SP. The information on the secondary channel may include an identification number (e.g., an index number or a channel index number) of the secondary channel and the maximum bandwidth of the secondary channel. The information on the SP is further described with reference to FIG. 14.

According to an embodiment, the second AP 1002 may receive the request frame 1010 from the first AP 1001. The second AP 1002 may transmit a response frame 1020 to the first AP 1001 in response to the request frame 1010. The response frame 1020 may include information (e.g., second information) on an SP (e.g., a second SP) that the second AP 1002 requests to communicate via the secondary channel (e.g., a second secondary channel).

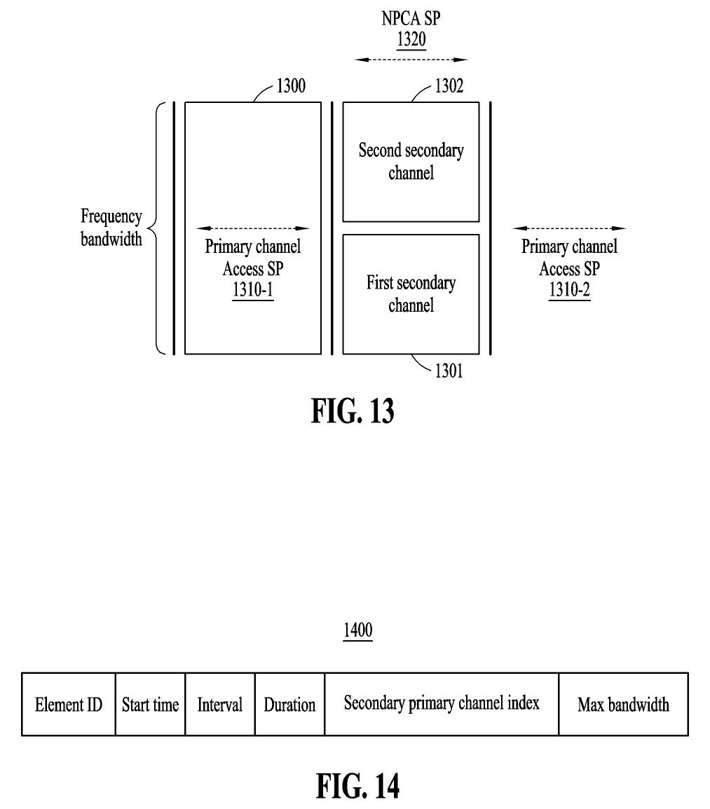

According to an embodiment, the first AP 1001 may receive the response frame 1020 from the second AP 1002. The first AP 1001 may negotiate the target SP by transmitting and receiving the information on the SP with the second AP 1002. The first AP 1001 and the second AP 1002 may negotiate a start time, an interval, and a duration of the target SP by transmitting and receiving the information on the SP and may negotiate which secondary channel to use (e.g., using different secondary channels in the first BSS and the second BSS) and how to set the maximum bandwidth during the target SP in each BSS (e.g., the first BSS and/or the second BSS). For example, the first AP 1001 and the second AP 1002 may determine the target SP by determining whether to accept the information on the SP that is transmitted by a counterpart while transmitting and/or receiving the request frame 1010 and/or the response frame 1020 one or more times. For example, the first AP 1001 may identify whether the second AP 1002 accepts the first SP included in the request frame 1010 from the second AP 1002 through the response frame 1020. When the second AP 1002 accepts the first SP, the first AP 1001 may determine the first SP to be the target SP. When the second AP 1002 does not accept the first SP and suggests another SP (e.g., a second SP), the first AP 1001 may determine whether to accept the second SP and transmit the result to the second AP 1002. When the second AP 1002 rejects the first SP without making another suggestion, the NPCA negotiation may be terminated. A specific NPCA negotiation method is further described with reference to FIG. 15.

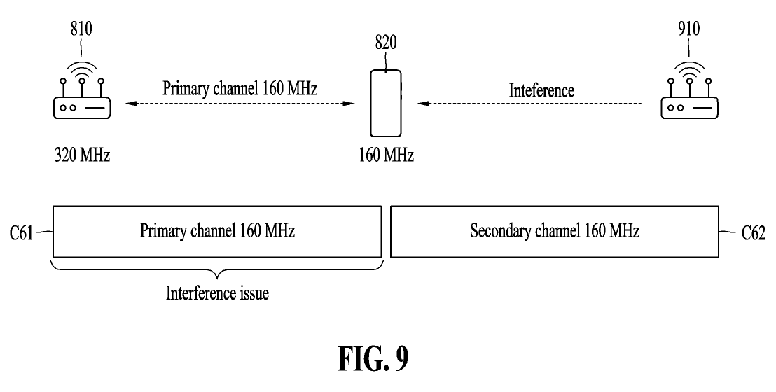

According to an embodiment, the first AP 1001 may broadcast the information on the negotiated target SP in the first BSS, and the second AP 1002 may broadcast the information on the negotiated target SP in the second BSS. The first STAs in the first BSS and the second STAs in the second BSS may identify the information on the negotiated target SP. Accordingly, based on the information on the target SP, the STAs in each BSS may access the wireless channel via the primary channel outside the target SP and may access the wireless channel via the secondary channel for each BSS according to the result of negotiation without separate frame detection in the target SP. That is, as the STAs perform NPCA in a predetermined SP regardless of the traffic state of the STAs according to the negotiation between the APs, since there is no need to perform separate frame detection, synchronization of the electronic devices in the BSS with respect to NPCA may be facilitated. Hereinafter, before describing a specific NPCA negotiation method between APs, a multi-AP cooperation system for negotiation between APs is described with reference to FIGS. 11A and 11B.

FIG. 11A is a diagram illustrating an example of a multi-AP cooperation system, according to an embodiment.

According to an embodiment, in the multi-AP cooperation system, resource utilization efficiency and performance may be improved by having adjacent APs, which share frequency resources, exchange information and/or cooperate, when compared to related wireless communication systems. The multi-AP cooperation system may be a system in which the APs cooperate on a 1:1 basis, as shown in FIG. 11A.

Referring to FIG. 11A, according to an embodiment, the multi-AP cooperation system may include the first AP 1001 (e.g., the AP 401 of FIG. 3 and/or the first AP 810 of FIG. 9) and the second AP 1002 (e.g., the AP 401 of FIG. 3 and/or the second AP 910 of FIG. 9). The first AP 1001 and the second AP 1002 may form an OBSS. The first AP 1001 and the second AP 1002 may perform information exchange and/or cooperation on a 1:1 basis. Hereinafter, an example of a 1:1 cooperation method is described.

According to an embodiment, the first AP 1001 may discover the second AP 1002 that forms an adjacent BSS. The first AP 1001 may negotiate what type of cooperation is to be performed with the second AP 1002. For example, when a primary channel of a second BSS that is adjacent to a first BSS at least partially overlaps a primary channel of the first BSS, it may be advantageous for electronic devices included in each BSS to access a wireless channel via different secondary channels during the same SP. That is, it may be advantageous for electronic devices (e.g., the first AP 1001 and/or the first STAs) included in the first BSS and electronic devices (e.g., the second AP 1002 and/or the second STAs) included in the second BSS to perform NPCA simultaneously during a predetermined SP. The first AP 1001 may request the second AP 1002 to negotiate NPCA to perform the NPCA simultaneously.

According to an embodiment, the first AP 1001 may negotiate with the second AP 1002 the necessary contents according to a specific cooperation target. For example, it may be assumed that the first AP 1001 and the second AP 1002 negotiate to perform NPCA simultaneously according to the request of the first AP 1001. The first AP 1001 and the second AP 1002 may negotiate a specific (target) NPCA SP (e.g., how to set an NPCA SP and how to set a secondary channel to be used during an NPCA SP).

FIG. 11B is a diagram illustrating an example of a multi-AP cooperation system, according to an embodiment.

The multi-AP cooperation system may be a system in which a plurality of APs cooperates by one or more controllers, as shown in FIG. 11B.

Referring to FIG. 11B, the multi-AP cooperation system may include a communication device 1100 and a plurality of APs (e.g., the first AP 1001, the second AP 1002, and an AP 1003). For the plurality of APs (e.g., the first AP 1001, the second AP 1002, and the AP 1003) to exchange information and/or cooperate with each other, a multi-AP cooperation environment must be created so that the plurality of APs (e.g., the first AP 1001, the second AP 1002, and the AP 1003) is coordinated. To coordinate the plurality of APs, links may need to be established between the plurality of APs (e.g., the first AP 1001, the second AP 1002, and the AP 1003), and information necessary for multi-AP cooperation, such as, but not limited to, information on the STAs associated with each AP (e.g., the first AP 1001, the second AP 1002, and the AP 1003), may need to be shared.

According to an embodiment, the communication device 1100 may manage and control (or coordinate) the plurality of APs (e.g., the first AP 1001, the second AP 1002, and the AP 1003). The communication device 1100 may manage information on a BSS formed by each of the plurality of APs (e.g., the first AP 1001, the second AP 1002, and the AP 1003) and/or information on an STA associated with a corresponding BSS. For example, the communication device 1100 may receive each of the pieces of information on an SP to perform NPCA from the plurality of APs (e.g., the first AP 1001, the second AP 1002, and the AP 1003), aggregate the pieces of information on the SP, and determine a target SP. The communication device 1100 may transmit information on the determined target SP to the plurality of APs (e.g., the first AP 1001, the second AP 1002, and the AP 1003).

According to an embodiment, the communication device 1100 may initiate and control multi-AP cooperation. For example, the communication device 1100 may group or select the APs (e.g., the first AP 1001, the second AP 1002, and the AP 1003) to perform information exchange and/or cooperation and may manage the links with the APs so that information is shared between the APs.

According to an embodiment, the APs (e.g., the first AP 1001, the second AP 1002, and the AP 1003) may perform the same function as an AP that may form a BSS in a WLAN system (e.g., the WLAN system 10 of FIG. 1 and/or the WLAN system 20 of FIG. 2), be coordinated by the communication device 1100, and exchange information and cooperate with each other. For example, the APs (e.g., the first AP 1001, the second AP 1002, and the AP 1003) may establish association with the communication device 1100 and may share information (e.g., control information, management information, and data traffic) with the communication device 1100.

According to an embodiment, the communication device 1100 may be referred to as an AP controller, a master AP, or a sharing AP. The communication device 1100 is a device to control multi-AP cooperation and may be referred to by various terms. The APs (e.g., the first AP 1001, the second AP 1002, and the AP 1003) capable of participating in multi-AP cooperation may be referred to as slave APs or shared APs. The APs (e.g., the first AP 1001, the second AP 1002, and the AP 1003) capable of participating in multi-AP cooperation are devices to perform multi-AP cooperation under the control of the communication device 1100 and may be referred to by various terms.

According to an embodiment, the multi-AP cooperation system is not limited to the structure shown in FIGS. 11A and 11B and may be implemented in various forms.

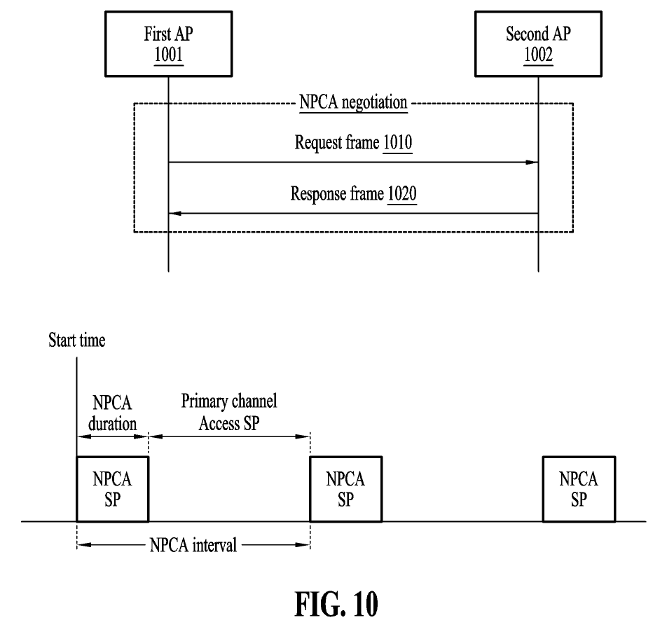

FIG. 12 is a diagram illustrating an operation of negotiating NPCA between APs, according to an embodiment.

Referring to FIG. 12, according to an embodiment, the first AP 1001 (e.g., the AP 401 of FIG. 3 and/or the first AP 810 of FIG. 9) and the second AP 1002 (e.g., the AP 401 of FIG. 3 and/or the second AP 910 of FIG. 9) may perform NPCA negotiation. The first AP 1001 and the second AP 1002 may negotiate to perform NPCA simultaneously.

According to an embodiment, the first AP 1001 and the second AP 1002 may be implemented as a multi-link device (MLD). The first AP 1001 and the second AP 1002 may perform a multi-link operation (MLO) in which communication is performed using a plurality of individual links. Even in a multi-link situation, the first AP 1001 and the second AP 1002 may perform NPCA negotiation. For example, the first AP 1001 and the second AP 1002 may perform NPCA negotiation on one of a plurality of links and may equally apply, to other links, the result of NPCA negotiation that is performed on one link. For example, the first AP 1001 and the second AP 1002 may perform NPCA negotiation on each of the individual links. Hereinafter, for ease of description, a method of performing NPCA negotiation on one link is described. However, as described above, the method of performing NPCA, according to an embodiment, may also be applied in a multi-link situation.

According to an embodiment, the first AP 1001 may form a first BSS, and the second AP 1002 may form a second BSS. The first BSS may be adjacent to the second BSS. The first AP 1001 may detect an adjacent second BSS that at least partially overlaps a primary channel of the first BSS. When an adjacent BSS does not exist, NPCA negotiation may not be necessary since there is no AP to negotiate NPCA. When an adjacent BSS exists but does not at least partially overlap the primary channel of the first BSS, NPCA negotiation may not be necessary since there are no external electronic devices participating in contention in the primary channel of the first BSS. Accordingly, NPCA negotiation may be necessary when an adjacent BSS exists and the primary channel of the adjacent BSS at least partially overlaps the primary channel of the first BSS. Hereinafter, it may be premised that there is the second AP 1002 that forms the second BSS at least partially overlapping the primary channel of the first BSS.

According to an embodiment, the first AP 1001 may trigger NPCA negotiation based on the ratio at which a partial bandwidth, which is a portion of the maximum bandwidth supported by the first AP 1001, is used in the first BSS. When the ratio at which the partial bandwidth is used is relatively small or nonexistent (e.g., when most and/or all electronic devices (e.g., a first STA 1201 and/or first STA 1202) in the first BSS use the maximum bandwidth supported by the first AP 1001), the frequency resource underutilization issue described with reference to FIG. 8A may rarely occur and/or may be avoided, and thus, NPCA negotiation may not be needed. Accordingly, the first AP 1001 may trigger NPCA negotiation when the ratio at which the partial bandwidth, which is a portion of the maximum bandwidth supported by the first AP 1001, is used in the first BSS is greater than a threshold value. That is, the first AP 1001 may trigger the transmission of a request frame to the second AP 1002 when the ratio at which the partial bandwidth, which is a portion of the maximum bandwidth supported by the first AP 1001, is used in the first BSS is greater than the threshold value. In such a case, when transmitting the request frame, the ratio at which the partial bandwidth, which is a portion of the maximum bandwidth supported by the second AP 1002, is used in the second BSS may not be considered. That is, a need to consider whether the frequency resource underutilization issue occurs in the second BSS may be avoided when preventing the frequency resource underutilization issue from occurring in the first BSS. For example, when NPCA is not performed, the electronic devices in the second BSS may also not be able to use the primary channel during the period in which the partial bandwidth including the primary channel is used in the first BSS. In such a case, it may be advantageous to allow the electronic devices (e.g., a second STA 1211 and/or a second STA 1212) in the second BSS to access a wireless channel even via other secondary channels during a corresponding period by accessing the wireless channel via the secondary channel through NPCA during the period in which the partial bandwidth is used in the first BSS.

According to an embodiment, the first AP 1001 may calculate the ratio at which the partial bandwidth, which is a portion of the maximum bandwidth supported by the first AP 1001, is used. There may be various cases or scenarios in which the partial bandwidth is used. For example, the partial bandwidth may be used when an electronic device (e.g., an electronic device that supports the maximum bandwidth that is less than the maximum bandwidth supported by the first AP 1001) having constraints on frequency bandwidth-related capabilities accesses the wireless channel. For example, even for the electronic device (e.g., the first STA 1201 and/or the first STA 1202) capable of supporting the maximum bandwidth supported by the first AP 1001, when the distance from the first AP 1001 is relatively long, the signal strength may be weakened, and thus, the partial bandwidth may be used. As another example, the partial bandwidth may be used when the electronic device (e.g., the first STA 1201 and/or the first STA 1202) is in a weak electric field (e.g., a region with a weak radio wave).

The first AP 1001 may calculate the ratio at which the partial bandwidth is used in the first BSS according to various situations described above. For example, the first AP 1001 may identify the frequency bandwidth-related capabilities of the electronic device (e.g., the first STA 1201 and/or the first STA 1202) included in the first BSS. For example, when the maximum bandwidth supported by the first AP 1001 is 320 MHz, the first AP 1001 may identify the number of STAs (e.g., the first STA 1201 and/or the first STA 1202) that maximally supports a frequency bandwidth (e.g., 160 MHz, 80 MHz, 40 MHz, and/or 20 MHz) that is less than that of 320 MHz in the first BSS and the amount of traffic of the STAs that maximally supports a frequency bandwidth that is less than that of 320 MHz. In addition, the first AP 1001 may identify the number of STAs (e.g., the first STA 1201 and/or the first STA 1202) that uses the partial bandwidth by distance and the amount of traffic of the STAs. Additionally, the first AP 1001 may identify the number of STAs (e.g., the first STA 1201 and/or the first STA 1202) that uses the partial bandwidth and the amount of traffic thereof as the first AP 1001 is in a weak electric field. As such, the first AP 1001 may identify factors according to various situations in which the partial bandwidth is used and may calculate the ratio at which the partial bandwidth is used.

According to an embodiment, the first AP 1001 may generate first information based on the ratio at which the partial bandwidth, which is a portion of the maximum bandwidth supported by the first AP 1001, is used. The first AP 1001 may set a duration and/or an interval of an SP that needs to access the wireless channel via a first secondary channel according to the ratio at which the partial bandwidth is used. For example, the first AP 1001 may set the duration and/or the interval of the SP to be greater as the ratio at which the partial bandwidth is used increases.

According to an embodiment, the first AP 1001 may transmit a request frame including the first information to the second AP 1002. The first AP 1001 may receive a response frame including second information from the second AP 1002. The first AP 1001 and the second AP 1002 may negotiate a target SP by transmitting and receiving information (e.g., the first information and/or the second information) on an SP (e.g., a first SP and/or a second SP). The first AP 1001 may determine the target SP based on at least one of the first information and the second information. The first AP 1001 and the second AP 1002 may negotiate a start time, an interval, and a duration of the target SP by transmitting and receiving the information on the SP and may negotiate which secondary channel to use (e.g., using different secondary channels in the first BSS and the second BSS) and how to set the maximum bandwidth during the target SP in each BSS (e.g., the first BSS and/or the second BSS). For example, when a second secondary channel of the second information that is received from the second AP 1002 at least partially overlaps the first secondary channel, the first AP 1001 may request modified second information from the second AP 1002. For example, the first AP 1001 may calculate the duty cycle of a first SP and the duty cycle of a second SP based on the first information and the second information, respectively. The first AP 1001 may determine an SP with a greater duty cycle to be the target SP. When the duty cycle of the second SP is greater than the duty cycle of the first SP, the first AP 1001 may transmit, to the second AP 1002, information indicating acceptance of the second information.

According to an embodiment, the first AP 1001 may broadcast the information on the target SP in the first BSS. The first AP 1001 may broadcast, to one or more external electronic devices (e.g., the first STA 1201 and the first STA 1202) (e.g., a first STA) included in the first BSS, the information on the target SP as part of a frame. The frame may include one of a beacon frame and a channel switching announcement (CSA) frame. For example, when the information on the target SP is transmitted as part of the beacon frame and when the version of the electronic devices (e.g., the first STA 1201 and the first STA 1202) is higher than Wi-Fi 7 (e.g., IEEE 802.11be), the electronic devices may perform NPCA during the target SP according to the NPCA protocol supported by Wi-Fi 7. However, when the version of the electronic devices (e.g., the first STA 1201 and the first STA 1202) is less than Wi-Fi 7 (e.g., IEEE 802.11be), the electronic devices may not perform NPCA, even when the information on the target SP is obtained (e.g., received). Accordingly, to allow a legacy device with a version less than Wi-Fi 7 (e.g., IEEE 802.11be) to access the wireless channel via the secondary channel in substantially the same manner as NPCA, the first AP 1001 may broadcast the information on the target SP as part of the CSA frame. That is, the first AP 1001 may transform the information on the target SP according to the CSA protocol and broadcast the information on the target SP in the first BSS. The second AP 1002 may also broadcast the information on the target SP in the second BSS in substantially the same manner as the first AP 1001.

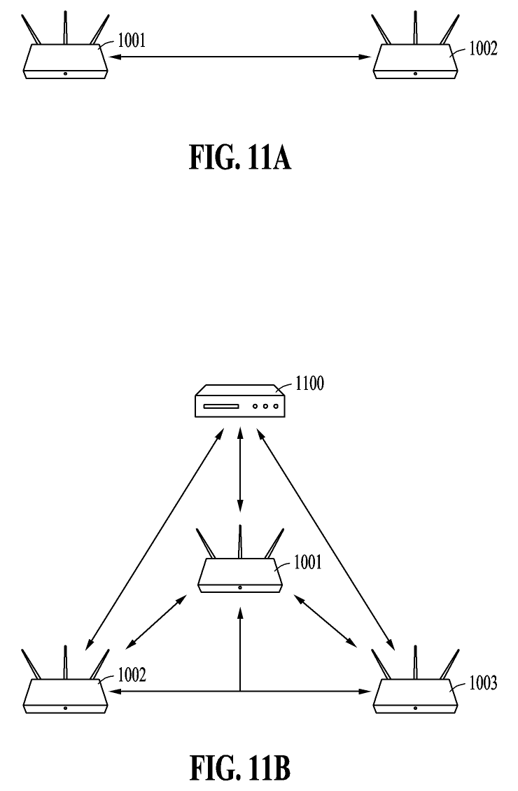

According to an embodiment, the STAs (e.g., the first STA 1201, the first STA 1202, the second STA 1211, and the second STA 1212) may access the wireless channel via the negotiated secondary channel during the target SP based on the information on the target SP. The operation of the STAs (e.g., the first STA 1201, the first STA 1202, the second STA 1211, and the second STA 1212) according to the result of negotiation is further described with reference to FIG. 13.

FIG. 13 is a diagram illustrating an NPCA negotiation result, according to an embodiment.

Referring to FIG. 13, according to an embodiment, a bandwidth 1300 may be the maximum bandwidth supported by an AP (e.g., the first AP 1001 and/or the second AP 1002 of FIG. 10) and may be a bandwidth including a primary channel. A bandwidth 1301 may be the maximum bandwidth including a first secondary channel, and a bandwidth 1302 may be the maximum bandwidth including a second secondary channel. Hereinafter, it may be premised that the first AP 1001 and the second AP 1002 negotiate access to a wireless channel via different secondary channels (e.g., the first secondary channel and the second secondary channel) during a target SP (e.g., an NPCA SP 1320).

According to an embodiment, STAs (e.g., first STAs and/or second STAs) included in a BSS (e.g., a first BSS and/or a second BSS) that shares a frequency may access the wireless channel via the bandwidth 1300 including the primary channel during a PCA SP 1310-1. For example, the STAs (e.g., the first STA 1201, the first STA 1202, the second STA 1211, and the second STA 1212) may perform contention to occupy the bandwidth 1300.

According to an embodiment, a target SP 1320 may arrive after the PCA SP 1310-1 elapses. When the target SP 1320 arrives, the first STA may change the primary channel to the first secondary channel and may access the wireless channel through the bandwidth 1301 according to the maximum bandwidth (e.g., the maximum bandwidth that is negotiated when determining the target SP) as a result of negotiation. The second STA may also change the primary channel to the second secondary channel and may access the wireless channel through the bandwidth 1302 according to the maximum bandwidth (e.g., the maximum bandwidth that is negotiated when determining the target SP) as a result of negotiation. Accordingly, during the target SP 1320, the first STA and the second STA may access the wireless channel through different bandwidths 1301 and 1302, and thus, interference may not occur therebetween.

According to an embodiment, a PCA SP 1310-2 may arrive after the target SP 1320 elapses. When the PCA SP 1310-2 arrives, as in the PCA SP 1310-1, the STAs (e.g., the first STAs and/or the second STAs) may access the wireless channel through the bandwidth 1300 including the primary channel.

FIG. 14 is a diagram illustrating an example of information on an SP that may be communicated via a secondary channel.

Referring to FIG. 14, according to an embodiment, to negotiate NPCA between APs (e.g., the first AP 1001 and/or the second AP 1002 of FIG. 10) and to broadcast information on a target SP in a BSS (e.g., a first BSS and/or a second BSS), an element 1400 capable of indicating the information on the SP may be needed. For example, the first AP 1001 may transmit, to the second AP 1002, a request frame (e.g., the request frame 1010 of FIG. 10) including the element 1400. The second AP 1002 may transmit, to the first AP 1001, a response frame (e.g., the response frame 1020 of FIG. 10) including the element 1400. The first AP 1001 may broadcast a frame (e.g., a beacon frame and/or a CSA frame) including the element 1400 in the first BSS. The second AP 1002 may broadcast the frame (e.g., a beacon frame and/or a channel CSA frame) including the element 1400 in the second BSS.

According to an embodiment, the information on the SP may include information on a secondary channel, a start time of the SP, an interval of the SP, and a duration of the SP. The information on the secondary channel may include an identification number of the secondary channel and the maximum bandwidth of the secondary channel.

According to an embodiment, the first AP 1001 may calculate the ratio at which a partial bandwidth, which is a portion of the maximum bandwidth supported by the first AP 1001, is used. The first AP 1001 may identify frequency bandwidth-related capabilities of electronic devices (e.g., the first STA 1201 and/or the first STA 1202) included in the first BSS. For example, when the maximum bandwidth supported by the first AP 1001 is 320 MHz, the first AP 1001 may identify the number of STAs (e.g., the first STA 1201 and/or the first STA 1202) that maximally supports a frequency bandwidth (e.g., 160 MHz, 80 MHz, 40 MHz, and/or 20 MHz) that is less than that of 320 MHz in the first BSS and the amount of traffic of the STAs that maximally supports the frequency bandwidth that is less than that of 320 MHz. In addition, the first AP 1001 may identify the number of STAs (e.g., the first STA 1201 and/or the first STA 1202) that uses the partial bandwidth by distance and the amount of traffic of the STAs. Additionally, the first AP 1001 may identify the number of STAs (e.g., the first STA 1201 and/or the first STA 1202) that uses the partial bandwidth and the amount of traffic thereof as the first AP 1001 is in a weak electric field. As such, the first AP 1001 may identify factors according to various situations in which the partial bandwidth is used and may calculate the ratio at which the partial bandwidth is used.

According to an embodiment, the first AP 1001 may generate first information based on the ratio at which the partial bandwidth, which is a portion of the maximum bandwidth supported by the first AP 1001, is used. The first AP 1001 may set a duration and/or an interval of a first SP that must access a wireless channel via a first secondary channel according to the ratio at which the partial bandwidth is used. That is, the first AP 1001 may set the duration and/or the interval of the first SP according to the ratio at which the partial bandwidth is used in the entire communication period. For example, the first AP 1001 may set the duration and/or the interval of the SP to be greater as the ratio at which the partial bandwidth is used increases.

According to an embodiment, the start time of the SP may need to be synchronized in the first AP 1001 and the second AP 1002. Synchronization of the start time of the SP may be performed through a timing synchronization function (TSF) when broadcasting the NPCA negotiation and/or the negotiated result (e.g., the information on the target SP) and may also be performed using an absolute TSF value. For example, the first AP 1001 and the second AP 1002 may synchronize the start time by exchanging the start time through NPCA negotiation. The first AP 1001 and the second AP 1002 may set the start time in the NPCA negotiation stage to a time after a reference time, based on the time at which a frame (e.g., the request frame 1010 of FIG. 10 and/or the response frame 1020 of FIG. 10) is transmitted. The first AP 1001 and/or the second AP 1002 may store the reception and transmission time of the frame (e.g., the request frame 1010 and/or the response frame 1020) based on the TSF in each BSS and may use the reception and transmission time when performing broadcasting in the BSS. For example, when the information on the target SP is broadcast in the BSS, the start time of the target SP may be set to a time after a reference value based on a time stamp of a corresponding frame (e.g., a beacon frame and/or a CSA frame). As another example, the start time may be set to the absolute TSF value. The method of synchronizing the start time is not limited to the example described above and may be performed through various methods. For example, there may be a TSF that performs separate management for cooperation between the APs (e.g., the first AP 1001 and/or the second AP 1002) or may be performed by a method of synchronizing the TSF itself between BSSs.

According to an embodiment, the element 1400 may include the information on the SP described above. The element 1400 may be transmitted by being included in the request frame (e.g., the request frame 1010 of FIG. 10) and/or the response frame (e.g., the response frame 1020 of FIG. 10) in the NPCA negotiation process described with reference to FIG. 10. For example, when the first AP 1001 transmits the request frame 1010, the first AP 1001 may store, in the element 1400, information on the first SP that is generated by the first AP 1001 and may transmit the information on the first SP to the second AP 1002 by including the element 1400 in the request frame 1010. When the second AP 1002 transmits the response frame 1020, the second AP 1002 may store, in the element 1400, information on a second SP that is generated by the second AP 1002 and transmit the information on the second SP to the first AP 1001 by including the element 1400 in the response frame 1020. In addition, the first AP 1001 and/or the second AP 1002 may store the information on the target SP in the negotiated element 1400 and broadcast the information on the target SP in each BSS (e.g., the first BSS and/or the second BSS) by including the element 1400 in a part of the frame and/or the CSA frame.

FIG. 15 is a diagram illustrating an example of an NPCA negotiation process between APs through a command field, according to an embodiment.

Referring to FIG. 15, according to an embodiment, an element 1500 may be an element in which a command field 1501 is added to an element (e.g., the element 1400 of FIG. 14). The command field 1501 may indicate a purpose (e.g., a request, suggestion, rejection, and/or alternative) of a frame that is transmitted and received during a negotiation process between the first AP 1001 (e.g., the first AP 1001 of FIG. 10) and the second AP 1002 (e.g., the second AP 1002 of FIG. 10). The element 1500 capable of indicating information on an SP may be required to negotiate NPCA between the first AP 1001 and the second AP 1002 and/or broadcast information on a target SP in a BSS. For example, the first AP 1001 may transmit, to the second AP 1002, a request frame (e.g., the request frame 1010 of FIG. 10) including the element 1500. The second AP 1002 may transmit, to the first AP 1001, a response frame (e.g., the response frame 1020 of FIG. 10) including the element 1500. The first AP 1001 may broadcast a frame (e.g., a beacon frame and/or a CSA frame) including the element 1500 in a first BSS. The second AP 1002 may broadcast a frame (e.g., a beacon frame and/or a CSA frame) including the element 1500 in a second BSS.

Hereinafter, the NPCA negotiation process between the first AP 1001 and the second AP 1002 through the command field 1501 is described.

Operations 1510 to 1540 may be performed sequentially but not necessarily. For example, the order of operations 1510 to 1540 may be changed, and at least two of operations 1510 to 1540 may be performed in parallel.

In operation 1510, the first AP 1001 may monitor the utilization ratio of a partial bandwidth. The first AP 1001 may trigger NPCA negotiation in response to the utilization ratio of the partial bandwidth being greater than or equal to a threshold value. The first AP 1001 may trigger operation 1520 in response to the utilization ratio of the partial bandwidth being greater than or equal to the threshold value.

In operation 1520, the first AP 1001 may transmit, to the second AP 1002, a request frame (e.g., the request frame 1010 of FIG. 10) including first information. The first AP 1001 may store a request in the command field 1501 of the element 1500 included in the request frame 1010 and may transmit the request to the second AP 1002.

In operation 1530, the second AP 1002 may transmit, to the first AP 1001, a response frame (e.g., the response frame 1020 of FIG. 10) including second information, in response to the request frame 1010. The second AP 1002 may determine whether to accept a first SP as the target SP based on at least one of the first information and the second information. For example, the second AP 1002 may accept the first SP when the duty cycle of the first SP is greater than the duty cycle of a second SP and a first secondary channel does not overlap a second secondary channel. In such a case, unlike as shown in FIG. 15, the second AP 1002 may store accept in the command field 1501 of the element 1500 included in the response frame 1020 and may transmit the accept to the first AP 1001. In contrast, when the first SP may not be accepted (e.g., when the duty cycle of the first SP is less than the duty cycle of the second SP or when the first secondary channel overlaps the second secondary channel), the second AP 1002 may store alternative and/or rejection in the command field 1501 of the element 1500 included in the response frame 1020 and may transmit the alternative and/or rejection to the first AP 1001. When alternative is stored in the command field 1501 of the element 1500 included in the response frame 1020 and transmitted, the second information may be included in the response frame 1020. However, when rejection is stored in the command field 1501 of the element 1500 included in the response frame 1020 and transmitted, the second information may not be included in the response frame 1020. Hereinafter, a case in which alternative is transmitted is described, as shown in FIG. 15.

In operation 1540, the first AP 1001 may determine whether to accept the second information included in the response frame 1020. The first AP 1001 may determine whether to accept the second SP as the target SP based on at least one of the first information and the second information. For example, the first AP 1001 may accept the second SP when the duty cycle of the second SP is greater than the duty cycle of the first SP and the first secondary channel does not overlap the second secondary channel. The first AP 1001 may not accept the second SP to be the target SP. In such a case, as described in operation 1530, the first AP 1001 may suggest an alternative (e.g., third information), other than the first information and the second information, to the second AP 1002 or may reject NPCA negotiation.

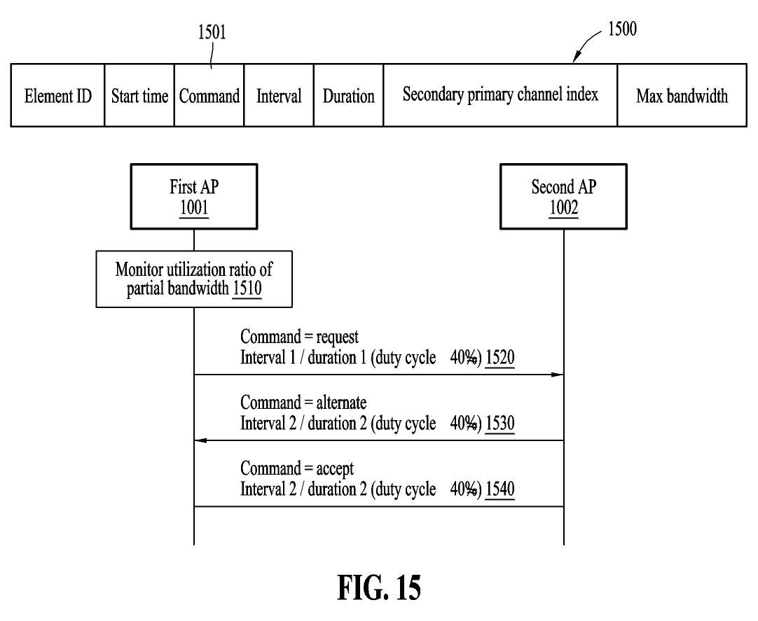

FIG. 16 is a diagram illustrating a method of renegotiating NPCA, according to an embodiment.

Referring to FIG. 16, according to an embodiment, the first AP 1001 (e.g., the AP 401 of FIG. 3 and/or the first AP 810 of FIG. 9) and the second AP 1002 (e.g., the AP 401 of FIG. 3 and/or the second AP 910 of FIG. 9) may perform NPCA negotiation and then may perform NPCA renegotiation when there is a change in traffic in each BSS.

According to an embodiment, when there is a change in the utilization ratio of a partial bandwidth in a first BSS, it may be necessary to change an SP in which NPCA is performed in the first BSS according to the changed utilization ratio. For example, among electronic devices (e.g., the first STA 1201 and/or the first STA 1202 of FIG. 12) connected to the first AP 1001, when the ratio of electronic devices that use the partial bandwidth is 40%, it may be assumed that a first target SP (e.g., an SP with a duty cycle of 40%) is determined through NPCA negotiation with the second AP 1002. In this case, among the electronic devices (e.g., the first STA 1201 and/or the first STA 1202 of FIG. 12), which are connected to the first AP 1001 at some point in time and have constraints in bandwidth-related capabilities, the ratio of the electronic devices that use the partial bandwidth may be reduced to 20%. Even though the ratio of the electronic devices (e.g., the first STA 1201 and/or the first STA 1202 of FIG. 12) connected to the first AP 1001 is reduced to 20%, it may still be inefficient to perform NPCA (e.g., access a wireless channel via a first secondary channel) during the first target SP (e.g., an SP with a duty cycle of 40%). That is, when such a change in traffic occurs, it may be necessary to change the previously negotiated target SP through renegotiation. Hereinafter, the NPCA renegotiation process is described in detail.

According to an embodiment, the first AP 1001 and the second AP 1002 may negotiate a target SP by exchanging information (e.g., information on an NPCA SP required according to the utilization ratio of the partial bandwidth in each BSS) through the request frame 1010 and/or the response frame 1020. For example, the first AP 1001 and the second AP 1002 may negotiate access to a wireless channel during the first target SP (e.g., an SP with a duty cycle of 40%) via different secondary channels (e.g., a first secondary channel and a second secondary channel).

In operation 1610-1, the first AP 1001 may broadcast information on the first target SP in the first BSS and may cause the electronic devices (e.g., the first STA 1201 and/or the first STA 1202 of FIG. 12) in the first BSS to access the wireless channel via a first secondary channel during the first target SP. In operation 1610-2, the second AP 1002 may also cause the electronic devices (e.g., the second STA 1211 and/or the second STA 1212 of FIG. 12) in a second BSS to access the wireless channel via a second secondary channel during the first target SP in substantially the same manner as in operation 1610-1.

According to an embodiment, a change in traffic may occur in the first BSS and/or the second BSS. For example, when NPCA negotiation is performed, it may be assumed that the duty cycle of a first SP required by the first AP 1001 is 40%, and the duty cycle of a second SP required by the second AP 1002 is 15%. Through NPCA negotiation, the first SP with a greater duty cycle may be determined to be the first target SP. However, among the electronic devices (e.g., the first STA 1201 and/or the first STA 1202 of FIG. 12) connected to the first AP 1001, the ratio of the electronic devices that use the partial bandwidth may be reduced to 20%. There may be electronic devices that use the partial bandwidth according to various situations in which the partial bandwidth is used, which is described with reference to FIG. 12, so redundant descriptions are omitted below for the sake of brevity. In response to the decrease in the ratio of the electronic devices that use the partial bandwidth in the first BSS, the first AP 1001 may request NPCA renegotiation with the second AP 1002.

According to an embodiment, after the target SP is determined, when there is a change in the ratio at which the partial bandwidth, which is a portion of the maximum bandwidth supported by the first AP 1001, is used in the first BSS, the first AP 1001 may modify first information (e.g., first information on the first SP used in NPCA negotiation) according to the change in the ratio at which the partial bandwidth is used. For example, among the electronic devices (e.g., the first STA 1201 and/or the first STA 1202 of FIG. 12) connected to the first AP 1001, when the ratio of the electronic devices that use the partial bandwidth is reduced from 40% to 20%, an interval and/or a duration of the first SP may be modified so that the duty cycle of the first SP becomes 20%.

According to an embodiment, the first AP 1001 may transmit, to the second AP 1002, a request frame 1620 including the modified first information. The first AP 1001 may receive, from the second AP 1002, a response frame 1630 corresponding to the request frame 1620. The response frame 1630 may include second information. The second information may be substantially the same as in the existing NPCA negotiation when, among the electronic devices (e.g., the second STA 1211 and/or the second STA 1212 of FIG. 12) connected to the second AP 1002, the ratio of the electronic devices that use the partial bandwidth is not changed, but when the ratio is changed, the second information may be modified according to the change. Hereinafter, it may be assumed that, among the electronic devices (e.g., the second STA 1211 and/or the second STA 1212 of FIG. 12) connected to the second AP 1002, the ratio of the electronic devices that use the partial bandwidth is not changed (e.g., when the duty cycle of the second SP is 15%).

According to an embodiment, the first AP 1001 may renegotiate the target SP with the second AP 1002 based on at least one of the request frame 1620 and the response frame 1630. The first AP 1001 may renegotiate the target SP with the second AP 1002 based on at least one of the modified first information included in the request frame 1620 (e.g., information on the first SP that is modified as the ratio of the electronic devices that use the partial bandwidth is reduced from 40% to 20% among the electronic devices (e.g., the first STA 1201 and/or the first STA 1202 of FIG. 12) connected to the first AP 1001) and the second information included in the response frame 1630 (e.g., information on the second SP with a duty cycle of 15%). For example, the existing first target SP may be determined based on the first SP with a greater duty cycle (e.g., an SP with a duty cycle of 40%). However, the duty cycle required in the modified first SP may be modified to 20% due to changes in traffic. Accordingly, the first AP 1001 may determine the modified first SP, which has a greater duty cycle between the modified first SP (e.g., an SP with a duty cycle of 20%) and the second SP (e.g., an SP with a duty cycle of 15%), to be a second target SP.

In operation 1640-1, the first AP 1001 may broadcast information on the second target SP in the first BSS. The electronic devices (e.g., the first STA 1201 and/or the first STA 1202) in the first BSS may perform NPCA during the second target SP based on the information on the second target SP. In operation 1640-2, the second AP 1002 may also broadcast the information on the second target SP in the second BSS in substantially the same manner as in operation 1640-1.

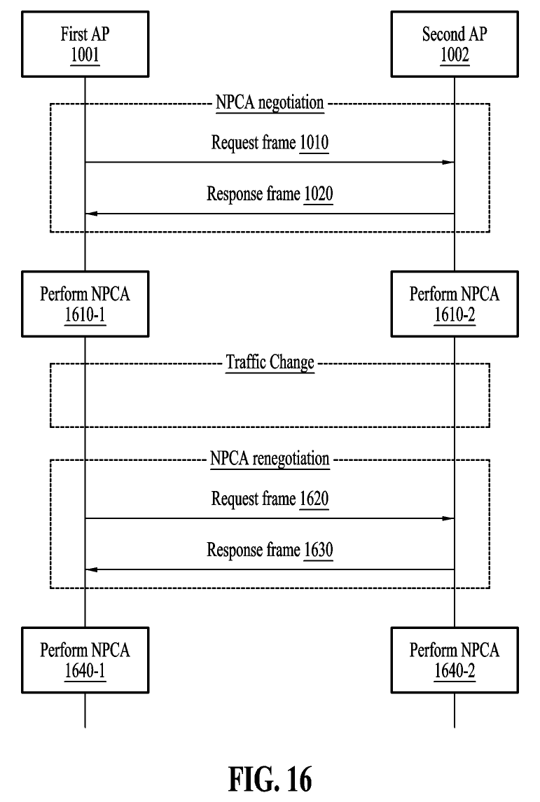

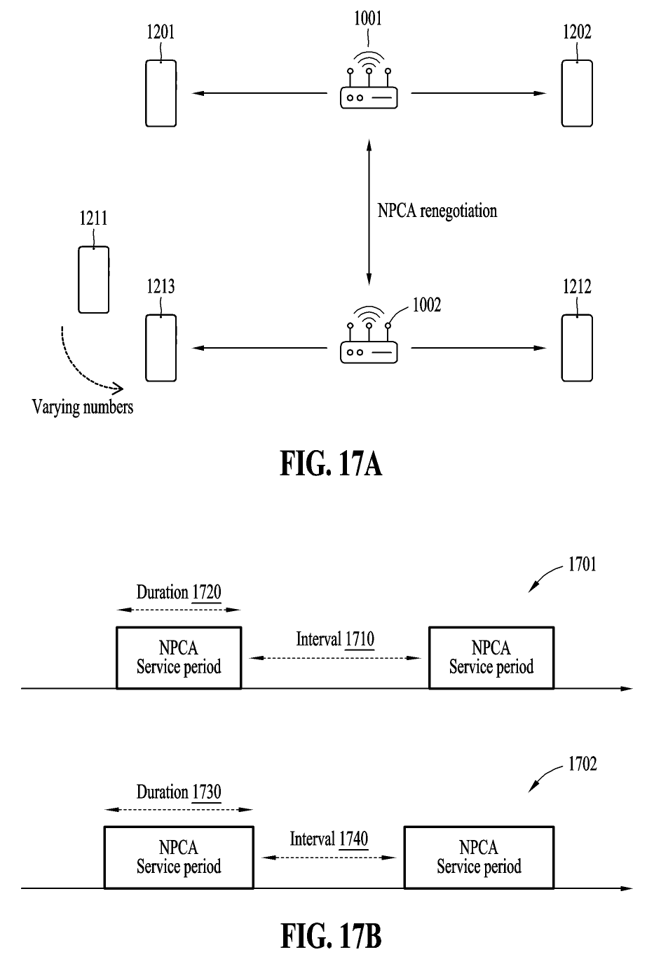

FIG. 17A is a diagram illustrating a situation in which NPCA renegotiation is needed, according to an embodiment.

Referring to FIG. 17A, according to an embodiment, the ratio at which a partial bandwidth is used in a first BSS and/or a second BSS may be changed. There may be various situations in which the utilization ratio of the partial bandwidth changes. For example, among electronic devices (e.g., the first STAs 1201 and 1202 and/or the second STAs 1211 to 1213), the ratio of electronic devices that use the partial bandwidth may change or the amount of traffic (e.g., the time to occupy a wireless channel) of the electronic devices that use the partial bandwidth may change. In addition, the utilization ratio of the partial bandwidth may change according to various situations, and FIG. 17A describes a case in which the ratio of the electronic devices that use the partial bandwidth changes.

In an embodiment, it may be premised that a first target SP to perform NPCA through NPCA negotiation between the first AP 1001 and the second AP 1002 is negotiated. The utilization ratio of the partial bandwidth in a BSS may change after NPCA negotiation (e.g., after the first target SP is determined). For example, the electronic devices (e.g., the second STAs 1211 and 1212) may be connected to the second AP 1002 during NPCA negotiation. However, as shown in FIG. 17A, at some point in time, the STA 1213 may be additionally connected to the second AP 1002. Here, the STA 1213 may have constraints in bandwidth-related capabilities (e.g., supporting a bandwidth (e.g., 80 MHz) that is less than the maximum bandwidth (e.g., 320 MHz) supported by the second AP 1002). Due to the addition of the STA 1213, a change in the ratio of the electronic devices that use the partial bandwidth in the second BSS may occur. When a change in the ratio of the electronic devices that use the partial bandwidth in the second BSS occurs, the second AP 1002 may request renegotiation with the first AP 1001 with respect to the first target SP.

FIG. 17B is a diagram illustrating an NPCA renegotiation result, according to an embodiment.

Referring to FIG. 17B, according to an embodiment, a negotiation result 1701 may represent a negotiation result at a previous point in time, and a negotiation result 1702 may represent a renegotiation result. For example, as shown in FIG. 17A, when the ratio of the electronic devices that use the partial bandwidth in the second BSS increases due to the addition of the STA 1213, NPCA renegotiation may be performed so that a second target SP has a greater duty cycle than the first target SP. That is, negotiation may be performed so that a duration 1730 of the second target SP is greater than a duration 1720 of the first target SP or an interval 1740 of the second target SP is less than an interval 1710 of the first target SP. Alternatively, negotiation may be performed so that the duration 1730 of the second target SP is greater than the duration 1720 of the first target SP and the interval 1740 of the second target SP is less than the interval 1710 of the first target SP.

According to an embodiment, although FIGS. 17A and 17B describe a case in which the ratio at which the partial bandwidth is used increases, NPCA renegotiation may be performed even when the ratio at which the partial bandwidth is used decreases. In this case, unlike in FIG. 17B, the second target SP may be negotiated to have a less duty cycle than the first target SP in the renegotiation result (e.g., the negotiation result 1702).

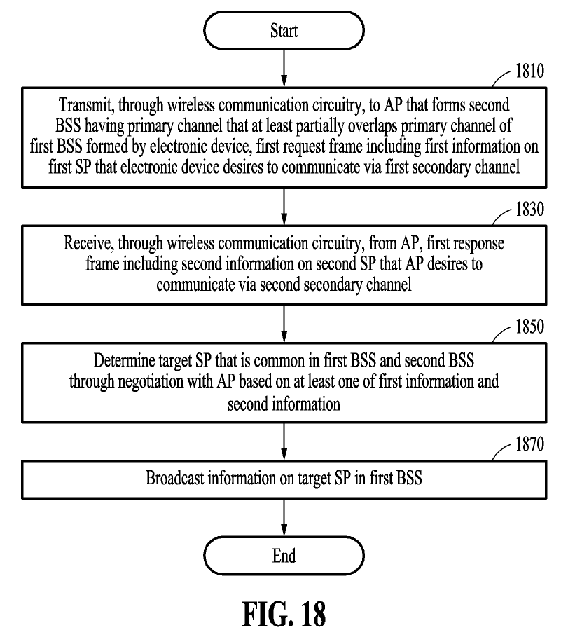

FIG. 18 is a flowchart illustrating an operation of an electronic device, according to an embodiment.

Referring to FIG. 18, operations 1810 to 1870 may be performed sequentially but not necessarily. For example, the order of operations 1810 to 1870 may be changed, and at least two of operations 1810 to 1870 may be performed in parallel.

In operation 1810, an electronic device (e.g., the first AP 1001 of FIG. 10) may transmit, through wireless communication circuitry (e.g., the transceiver 490 of FIG. 4), to an AP (e.g., the second AP 1002 of FIG. 10) that forms a second BSS having a primary channel that at least partially overlaps a primary channel of a first BSS formed by the first AP 1001, a first request frame including first information on a first SP that the electronic device (e.g., the first AP 1001 of FIG. 10) requests to communicate via a first secondary channel. The first information may include information on the first secondary channel, a start time of the first SP, an interval of the first SP, and/or a duration of the first SP. The information on the first secondary channel may include an identification number of the first secondary channel and/or the maximum bandwidth of the first secondary channel.

According to an embodiment, the first AP 1001 may calculate the ratio at which a partial bandwidth (e.g., 160 MHz, 80 MHz, 40 MHz, and/or 20 MHz), which is a portion of the maximum bandwidth (e.g., 320 MHz) supported by the first AP 1001, is used.

According to an embodiment, the first AP 1001 may generate the first information based on the ratio at which the partial bandwidth (e.g., 160 MHz, 80 MHz, 40 MHz, and/or 20 MHz), which is a portion of the maximum bandwidth (e.g., 320 MHz) supported by the first AP 1001, is used. The first AP 1001 may set the duration and/or the interval of the first SP according to the ratio at which the partial bandwidth is used. For example, the first AP 1001 may set the duration and/or the interval of the first SP to be greater as the ratio at which the partial bandwidth is used increases.

According to an embodiment, the first AP 1001 may trigger transmission of the first request frame based on the ratio at which the partial bandwidth is used. For example, the first AP 1001 may trigger transmission of the first request frame when the ratio at which the partial bandwidth is used is greater than or equal to a threshold value.

In operation 1830, the first AP 1001 may receive, through the wireless communication circuitry, from the AP (e.g., the second AP 1002 of FIG. 10), a first response frame including second information on a second SP that the second AP 1002 requests to communicate via a second secondary channel. The second information may include information on the second secondary channel, a start time of the second SP, an interval of the second SP, and/or a duration of the second SP. The information on the second secondary channel may include an identification number of the second secondary channel and/or the maximum bandwidth of the second secondary channel.

According to an embodiment, the second information may be set in substantially the same manner as the first information.

In operation 1850, the first AP 1001 may determine a target SP (e.g., the NPCA SP 1320 of FIG. 13) that is common in the first BSS and the second BSS through negotiation with the second AP 1002 based on at least one of the first information and the second information. The target SP 1320 may refer to a period in which NPCA is performed simultaneously in the first BSS and the second BSS. For example, during the target SP 1320, the electronic devices (e.g., the first STAs 1201 and 1202 of FIG. 12) included in the first BSS may access a wireless channel through a bandwidth (e.g., the bandwidth 1301 of FIG. 13) including the first secondary channel, and the electronic devices (e.g., the second STAs 1211 and 1212 of FIG. 12) included in the second BSS may access the wireless channel through a bandwidth (e.g., the bandwidth 1302 of FIG. 13) including the second secondary channel. Accordingly, interference between the first BSS and the second BSS may not occur during the target SP 1320.

In operation 1870, the first AP 1001 may broadcast information on the target SP in the first BSS. The first AP 1001 may broadcast, to external electronic devices (e.g., STAs (e.g., the first STAs 1201 and 1202)) in the first BSS, the information on the target SP as part of a frame (e.g., a beacon frame and/or a CSA frame).

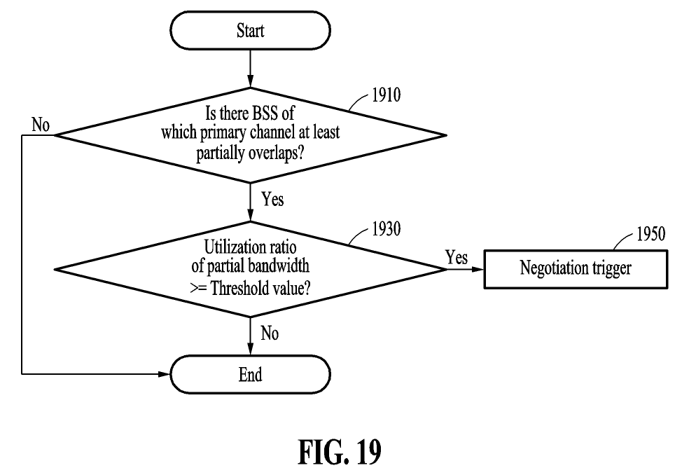

FIG. 19 is a diagram illustrating an operation of triggering NPCA negotiation, according to an embodiment.

Referring to FIG. 19, operations 1910 to 1950 may be performed sequentially but not necessarily. For example, the order of operations 1910 to 1950 may be changed, and at least two of operations 1910 to 1950 may be performed in parallel.

In operation 1910, an electronic device (e.g., the first AP 1001 of FIG. 10) may determine whether there is a primary channel of a BSS (e.g., an OBSS) (e.g., an adjacent BSS) that at least partially overlaps a primary channel of a BSS (e.g., a first BSS). The first AP 1001 may identify the presence or absence of an adjacent BSS by detecting a signal of the adjacent BSS. For example, it may be assumed that the second AP 1002 is adjacent to the first AP 1001 and the frequency resources are shared (e.g., a primary channel of a second BSS at least partially overlaps a primary channel of a first BSS). The first AP 1001 may identify the existence of a second BSS by detecting a signal of the second BSS.

According to an embodiment, when an OBSS does not exist (No at operation 1910), the first AP 1001 may terminate an operation. When the OBSS exists (Yes at operation 1910), the first AP 1001 may perform operation 1930.

In operation 1930, the first AP 1001 may calculate the utilization ratio of a partial bandwidth in a first BSS. The first AP 1001 may calculate the ratio at which the partial bandwidth is used in the first BSS, based on various situations in which the partial bandwidth is used. For example, the first AP 1001 may identify frequency bandwidth-related capabilities of electronic devices (e.g., the first STA 1201 and/or the first STA 1202) included in the first BSS. For example, when the maximum bandwidth supported by the first AP 1001 is 320 MHz, the first AP 1001 may identify the number of STAs (e.g., the first STA 1201 and/or the first STA 1202) that maximally supports a frequency bandwidth (e.g., 160 MHz, 80 MHz, 40 MHz, and/or 20 MHz) that is less than that of 320 MHz in the first BSS and the amount of traffic of the STAs that maximally supports a frequency bandwidth that is less than that of 320 MHz. In addition, the first AP 1001 may identify the number of STAs (e.g., the first STA 1201 and/or the first STA 1202) that uses the partial bandwidth by distance and the amount of traffic of the STAs. Additionally, the first AP 1001 may identify the number of STAs (e.g., the first STA 1201 and/or the first STA 1202) that uses the partial bandwidth and the amount of traffic thereof as the first AP 1001 is in a weak electric field. As such, the first AP 1001 may identify factors according to various situations in which the partial bandwidth is used and may calculate the ratio at which the partial bandwidth is used.

According to an embodiment, the first AP 1001 may terminate an operation when the utilization ratio of the partial bandwidth in the first BSS is less than a threshold value (No in operation 1930). In this case, this may be because the gain to be achieved through NPCA is small. The first AP 1001 may perform operation 1950 when the utilization ratio of the partial bandwidth in the first BSS is greater than or equal to the threshold value (Yes in operation 1930).

In operation 1950, the first AP 1001 may trigger negotiation (e.g., NPCA negotiation). The first AP 1001 may generate information on an SP requiring NPCA (e.g., an SP requiring access to a wireless channel via a secondary channel (e.g., having a bandwidth that is less than the maximum bandwidth including a primary channel) according to the utilization ratio of the partial bandwidth in the first BSS. The first AP 1001 may transmit, to the second AP 1002, a request frame including the information on the SP. The first AP 1001 may perform NPCA negotiation with the second AP 1002 by receiving a response frame from the second AP 1002.

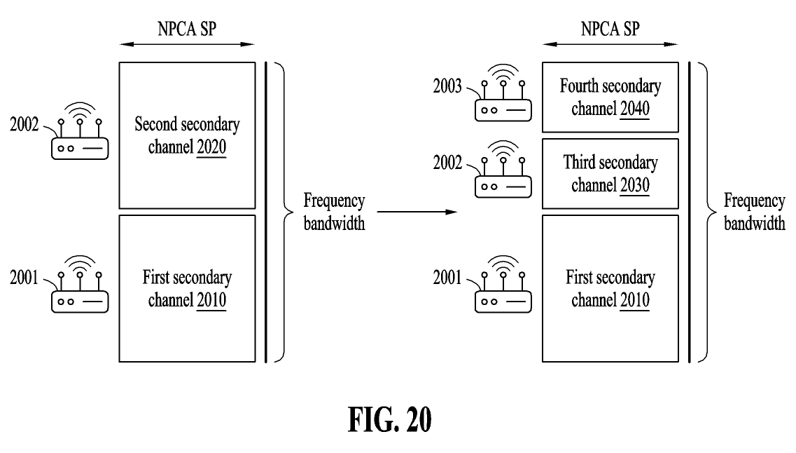

FIG. 20 is a diagram illustrating an NPCA negotiation method between three (3) or more APs, according to an embodiment.

Referring to FIG. 20, according to an embodiment, NPCA negotiation may be performed between a first AP 2001 (e.g., the first AP 1001 of FIG. 10) and a second AP 2002 (e.g., the second AP 1002 of FIG. 10), but a third AP 2003, which forms a third BSS having a primary channel that at least partially overlaps a primary channel of a first BSS of the first AP 2001 and a second BSS of the second AP 2002, may be added. For example, through NPCA negotiation between the first AP 2001 and the second AP 2002, negotiation may be performed for using half of the maximum bandwidth including the primary channel in the first BSS and the second BSS during a target SP. That is, during the target SP, negotiation may be performed to access a wireless channel through a bandwidth 2010 including a first secondary channel in the first BSS. During the target SP, negotiation may be performed to access the wireless channel through a bandwidth 2020 including a second secondary channel in the second BSS. Here, due to the addition of the third AP 2003, electronic devices existing in the third BSS may participate in contention during the target SP, which may cause interference to the first BSS and the second BSS. In this case, the third AP 2003 may solve the interference by performing NPCA negotiation with the first AP 2001 and/or the second AP 2002.

According to an embodiment, as shown in FIG. 20, there may be three (3) or more APs in an OBSS environment. Three (3) or more APs (e.g., the first to third APs 2001 to 2003) may simultaneously perform NPCA negotiation (e.g., exchange information through the communication device 1100 and/or perform negotiation in the multi-AP cooperation system of FIG. 11B) or each of the APs (e.g., the first to third APs 2001 to 2003) may perform NPCA negotiation on a 1:1 basis (e.g., exchange information on a 1:1 basis between the APs and/or perform negotiation in the multi-AP cooperation system of FIG. 11A). Hereinafter, it may be assumed that NPCA negotiation is performed on a 1:1 basis, but embodiments of the present disclosure are not limited thereto.

According to an embodiment, the third AP 2003 may determine the target SP through NPCA negotiation with the second AP 2002. The target SP of the third AP 2003 may be set according to the result of NPCA negotiation between the existing first AP 2001 and the second AP 2002, but the bandwidth for accessing the wireless channel during the target SP may be set so that the APs (e.g., the first to third APs 2001 to 2003) do not overlap each other. For example, through negotiation with the second AP 2002, the third AP 2003 may negotiate to divide and use the bandwidth 2020 including the second secondary channel that is previously used by the second AP 2002 during the target SP. The second AP 2002 and the third AP 2003 may divide the bandwidth 2020 including the second secondary channel into a bandwidth 2030 including a third secondary channel and a bandwidth 2040 including a fourth secondary channel and may negotiate with each other to use a corresponding bandwidth during the target SP. The bandwidth 2020 may be divided in half as shown in FIG. 20 but embodiments of the present disclosure is not limited thereto and may be divided differently depending on the difference in the utilization ratio of a partial bandwidth in the second BSS and the third BSS.

FIG. 21 is a block diagram illustrating a first electronic device 2101 (e.g., the AP 401 of FIG. 3, the electronic device 400 of FIG. 4, the first AP 810 of FIG. 8A, and the first AP 1001 of FIG. 10) in a network environment 2100, according to an embodiment. Referring to FIG. 21, the first electronic device 2101 in the network environment 2100 may communicate with a second electronic device 2102 (e.g., the second AP 910 of FIG. 8B or the second AP 1002 of FIG. 10) via a first network 2198 (e.g., a short-range wireless communication network), or at least one of an external electronic device 2104 or a server 2108 via a second network 2199 (e.g., a long-range wireless communication network). According to an embodiment, the first electronic device 2101 may communicate with the external electronic device 2104 via the server 2108. According to an embodiment, the first electronic device 2101 may include a processor 2120, memory 2130, an input module 2150, a sound output module 2155, a display module 2160, an audio module 2170, a sensor module 2176, an interface 2177, a connecting terminal 2178, a haptic module 2179, a camera module 2180, a power management module 2188, a battery 2189, a communication module 2190, a subscriber identification module (SIM) 2196, or an antenna module 2197. In some embodiments, at least one of the components (e.g., the connecting terminal 2178) may be omitted from the first electronic device 2101, or one or more other components may be added to the first electronic device 2101. In some embodiments, some of the components (e.g., the sensor module 2176, the camera module 2180, or the antenna module 2197) may be implemented as a single component (e.g., the display module 2160).

The processor 2120 may execute, for example, software (e.g., a program 2140) to control at least one other component (e.g., a hardware or software component) of the first electronic device 2101 coupled with the processor 2120 and may perform various data processing or computation. According to an embodiment, as at least part of the data processing or computation, the processor 2120 may store a command or data received from another component (e.g., the sensor module 2176 or the communication module 2190) in volatile memory 2132, process the command or the data stored in the volatile memory 2132, and store resulting data in non-volatile memory 2134. According to an embodiment, the processor 2120 may include a main processor 2121 (e.g., a CPU or an AP), or an auxiliary processor 2123 (e.g., a GPU, a neural processing unit (NPU), an image signal processor (ISP), a sensor hub processor, or a CP) that is operable independently from, or in conjunction with, the main processor 2121. For example, when the first electronic device 2101 includes the main processor 2121 and the auxiliary processor 2123, the auxiliary processor 2123 may be adapted to consume less power than the main processor 2121, or to be specific to a specified function. The auxiliary processor 2123 may be implemented as separate from, or as part of the main processor 2121.

The auxiliary processor 2123 may control at least some of functions or states related to at least one component (e.g., the display module 2160, the sensor module 2176, or the communication module 2190) among the components of the first electronic device 2101, instead of the main processor 2121 while the main processor 2121 is in an inactive (e.g., sleep) state, or together with the main processor 2121 while the main processor 2121 is in an active state (e.g., executing an application). According to an embodiment, the auxiliary processor 2123 (e.g., an ISP or a CP) may be implemented as part of another component (e.g., the camera module 2180 or the communication module 2190) functionally related to the auxiliary processor 2123. According to an embodiment, the auxiliary processor 2123 (e.g., the neural processing unit) may include a hardware structure specified for artificial intelligence model processing. An artificial intelligence model may be generated by machine learning. Such learning may be performed, e.g., by the first electronic device 2101 where the artificial intelligence is performed or via a separate server (e.g., the server 2108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), a deep Q-network or a combination of two or more thereof but is not limited thereto. The artificial intelligence model may, additionally or alternatively, include a software structure other than the hardware structure.

The memory 2130 may store various data used by at least one component (e.g., the processor 2120 or the sensor module 2176) of the first electronic device 2101. The various data may include, for example, software (e.g., the program 2140) and input data or output data for a command related thereto. The memory 2130 may include the volatile memory 2132 or the non-volatile memory 2134.

The program 2140 may be stored in the memory 2130 as software, and may include, for example, an operating system (OS) 2142, middleware 2144, or an application 2146.

The input module 2150 may receive a command or data to be used by another component (e.g., the processor 2120) of the first electronic device 2101, from the outside (e.g., a user) of the first electronic device 2101. The input module 2150 may include, for example, a microphone, a mouse, a keyboard, a key (e.g., a button), or a digital pen (e.g., a stylus pen).

The sound output module 2155 may output sound signals to the outside of the first electronic device 2101. The sound output module 2155 may include, for example, a speaker or a receiver. The speaker may be used for general purposes, such as, but not limited to, playing multimedia or playing record. The receiver may be used for receiving incoming calls. According to an embodiment, the receiver may be implemented as separate from, or as part of the speaker.

The display module 2160 may visually provide information to the outside (e.g., a user) of the first electronic device 2101. The display module 2160 may include, for example, a display, a hologram device, or a projector and control circuitry to control a corresponding one of the display, hologram device, and projector. According to an embodiment, the display module 2160 may include a touch sensor adapted to detect a touch, or a pressure sensor adapted to measure the intensity of force incurred by the touch.

The audio module 2170 may convert a sound into an electrical signal and vice versa. According to an embodiment, the audio module 2170 may obtain the sound via the input module 2150 or output the sound via the sound output module 2155 or an external electronic device (e.g., the second electronic device 2102) (e.g., a speaker or headphone) directly or wirelessly coupled with the first electronic device 2101.

The sensor module 2176 may detect an operational state (e.g., power or temperature) of the first electronic device 2101 or an environmental state (e.g., a state of a user) external to the first electronic device 2101 and then generate an electrical signal or data value corresponding to the detected state. According to an embodiment, the sensor module 2176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 2177 may support one or more specified protocols to be used for the first electronic device 2101 to be coupled with the external electronic device (e.g., the second electronic device 2102) directly (e.g., wiredly) or wirelessly. According to an embodiment, the interface 2177 may include, for example, a high definition multimedia interface (HDMI), a universal serial bus (USB) interface, a secure digital (SD) card interface, or an audio interface.

The connecting terminal 2178 may include a connector via which the first electronic device 2101 may be physically connected with the external electronic device (e.g., the second electronic device 2102). According to an embodiment, the connecting terminal 2178 may include, for example, an HDMI connector, a USB connector, an SD card connector, or an audio connector (e.g., a headphone connector).

The haptic module 2179 may convert an electrical signal into a mechanical stimulus (e.g., a vibration or a movement) or electrical stimulus which may be recognized by a user via his tactile sensation or kinesthetic sensation. According to an embodiment, the haptic module 2179 may include, for example, a motor, a piezoelectric element, or an electric stimulator.

The camera module 2180 may capture a still image or moving images. According to an embodiment, the camera module 2180 may include one or more lenses, image sensors, ISPs, or flashes.

The power management module 2188 may manage power supplied to the first electronic device 2101. According to an embodiment, the power management module 2188 may be implemented as at least part of, for example, a power management integrated circuit (PMIC).

The battery 2189 may supply power to at least one component of the first electronic device 2101. According to an embodiment, the battery 2189 may include, for example, a primary cell which is not rechargeable, a secondary cell which is rechargeable, or a fuel cell.

The communication module 2190 may support establishing a direct (e.g., wired) communication channel or a wireless communication channel between the first electronic device 2101 and the external electronic device (e.g., the second electronic device 2102, the external electronic device 2104, or the server 2108) and performing communication via the established communication channel. The communication module 2190 may include one or more CPs that are operable independently from the processor 2120 (e.g., the AP) and support a direct (e.g., wired) communication or a wireless communication. According to an embodiment, the communication module 2190 may include a wireless communication module 2192 (e.g., a cellular communication module, a short-range wireless communication module, or a global navigation satellite system (GNSS) communication module) or a wired communication module 2194 (e.g., a local area network (LAN) communication module or a power line communication (PLC) module). A corresponding one of these communication modules may communicate with the external electronic device 2104 via the first network 2198 (e.g., a short-range communication network, such as, but not limited to, Bluetooth™, Wi-Fi direct, or infrared data association (IrDA)) or the second network 2199 (e.g., a long-range communication network, such as, but not limited to, a legacy cellular network, a fifth-generation (5G) network, a next-generation communication network, the Internet, or a computer network (e.g., LAN or wide area network (WAN)). These various types of communication modules may be implemented as a single component (e.g., a single chip), or may be implemented as multiple components (e.g., multiple chips) separate from each other. The wireless communication module 2192 may identify and authenticate the first electronic device 2101 in a communication network, such as the first network 2198 or the second network 2199, using subscriber information (e.g., international mobile subscriber identity (IMSI)) stored in the subscriber identification module 2196.

The wireless communication module 2192 may support a 5G network, after a fourth generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 2192 may support a high-frequency band (e.g., the mmWave band) to achieve, e.g., a high data transmission rate. The wireless communication module 2192 may support various technologies for securing performance on a high-frequency band, such as, but not limited to, beamforming, massive multiple-input and multiple-output (massive MIMO), full dimensional MIMO (FD-MIMO), array antenna, analog beam-forming, or large scale antenna. The wireless communication module 2192 may support various requirements specified in the first electronic device 2101, an external electronic device (e.g., the external electronic device 2104), or a network system (e.g., the second network 2199). According to an embodiment, the wireless communication module 2192 may support a peak data rate (e.g., 20 Gbps or more) for implementing eMBB, loss coverage (e.g., 164 dB or less) for implementing mMTC, or U-plane latency (e.g., 0.5 ms or less for each of DL and UL, or a round trip of 1 ms or less) for implementing URLLC.

The antenna module 2197 may transmit or receive a signal or power to or from the outside (e.g., the external electronic device) of the first electronic device 2101. According to an embodiment, the antenna module 2197 may include an antenna including a radiating element composed of a conductive material or a conductive pattern formed in or on a substrate (e.g., a printed circuit board (PCB)). According to an embodiment, the antenna module 2197 may include a plurality of antennas (e.g., array antennas). In such a case, at least one antenna appropriate for a communication scheme used in the communication network, such as the first network 2198 or the second network 2199, may be selected, for example, by the communication module 2190 from the plurality of antennas. The signal or the power may then be transmitted or received between the communication module 2190 and the external electronic device via the selected at least one antenna. According to an embodiment, another component (e.g., a radio frequency integrated circuit (RFIC)) other than the radiating element may be additionally formed as part of the antenna module 2197.

According to various embodiments, the antenna module 2197 may form an mmWave antenna module. According to an embodiment, the mmWave antenna module may include a PCB, a RFIC disposed on a first surface (e.g., the bottom surface) of the PCB, or adjacent to the first surface and capable of supporting a designated high-frequency band (e.g., the mmWave band), and a plurality of antennas (e.g., array antennas) disposed on a second surface (e.g., the top or a side surface) of the PCB, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the first electronic device 2101 and the external electronic device 2104 via the server 2108 coupled with the second network 2199. Each of the electronic devices 2102 or 2104 may be a device of a same type as, or a different type, from the first electronic device 2101. According to an embodiment, all or some of operations to be executed at the first electronic device 2101 may be executed at one or more of the external electronic devices 2102, 2104, or 2108. For example, if the first electronic device 2101 should perform a function or a service automatically, or in response to a request from a user or another device, the first electronic device 2101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the first electronic device 2101. The first electronic device 2101 may provide the outcome, with or without further processing of the outcome, as at least part of a reply to the request. To that end, cloud computing, distributed computing, mobile edge computing (MEC), or client-server computing technology may be used, for example. The first electronic device 2101 may provide ultra-low latency services using, e.g., distributed computing or mobile edge computing. In another embodiment, the external electronic device 2104 may include an Internet-of-Things (IoT) device. The server 2108 may be an intelligent server using machine learning and/or a neural network. According to an embodiment, the external electronic device 2104 or the server 2108 may be included in the second network 2199. The first electronic device 2101 may be applied to intelligent services (e.g., smart home, smart city, smart car, or healthcare) based on 5G communication technology or IoT-related technology.

According to an embodiment, an electronic device (e.g., the AP 401 of FIG. 3, the electronic device 400 of FIG. 4, the first AP 810 of FIG. 8A, the first AP 1001 of FIG. 10, and/or the first electronic device 2101 of FIG. 21) may include wireless communication circuitry (e.g., the transceiver 490 of FIG. 4 and/or the communication module 2190 of FIG. 21). The electronic device (400, 401, 810, 1001, and 2101) may include at least one processor (e.g., the processor 410 of FIG. 4 and/or the processor 2120 of FIG. 21) including processing circuitry. The electronic device (400, 401, 810, 1001, and 2101) may include memory (e.g., the memory 420 of FIG. 4 and/or the memory 2130 of FIG. 21) storing instructions. The instructions, when executed by the at least one processor (410, 2120) individually or collectively, may cause the electronic device (400, 401, 810, 1001, and 2101) to transmit, through the wireless communication circuitry (490, 2190), to an access point (910, 1002), a first request frame requesting communication via a first secondary channel. The instructions, when executed by the at least one processor (410, 2120) individually or collectively, may cause the electronic device (400, 401, 810, 1001, and 2101) to receive, through the wireless communication circuitry (490, 2190), from the AP (910, 1002), a first response frame requesting communication via a second secondary channel. The instructions, when executed by the at least one processor (410, 2120) individually or collectively, may cause the electronic device (400, 401, 810, 1001, and 2101) to perform negotiation with the AP (910, 1002) based on at least one of the first information or the second information, to determine a target SP that is common in the first BSS and the second BSS. The instructions, when executed by the at least one processor (410, 2120) individually or collectively, may cause the electronic device (400, 401, 810, 1001, and 2101) to broadcast information on the target SP to the first BSS. The first request frame may include first information on a first service period (SP). The first response frame may include second information on a second SP. A first primary channel of a first BSS formed by the electronic device (400, 401, 810, 1001, and 2101) may at least partially overlap a second primary channel of a second BSS formed by the the AP (910, 1002).

According to an embodiment, the first information may include information on the first secondary channel, a start time of the first SP, an interval of the first SP, and a duration of the first SP. The second information may include information on the second secondary channel, a start time of the second SP, an interval of the second SP, and a duration of the second SP.

According to an embodiment, each of the information on the first secondary channel and the information on the second secondary channel may include an identification number of a channel and the maximum bandwidth of the channel.

According to an embodiment, the instructions, when executed by the at least one processor (410, 2120) individually or collectively, may cause the electronic device (400, 401, 810, 1001, and 2101) to determine a ratio of a partial bandwidth to the maximum bandwidth supported by the electronic device (400, 401, 810, 1001, and 2101). The instructions, when executed by the at least one processor (410, 2120) individually or collectively, may cause the electronic device (400, 401, 810, 1001, and 2101) to trigger transmission of the first request frame based on the ratio. The partial bandwidth may be a portion of the maximum bandwidth that is in use.

According to an embodiment, the instructions, when executed by the at least one processor (410, 2120) individually or collectively, may cause the electronic device (400, 401, 810, 1001, and 2101) to generate the electronic device (400, 401, 810, 1001, and 2101) to generate the first information based on a ratio of a partial bandwidth to the maximum bandwidth supported by the electronic device (400, 401, 810, 1001, and 2101). The partial bandwidth may be a portion of the maximum bandwidth that is in use.

According to an embodiment, the instructions, when executed by the at least one processor (410, 2120) individually or collectively, may cause the electronic device (400, 401, 810, 1001, and 2101) to determine, as the target SP, a SP having a greater duty cycle from the first SP and the second SP.

According to an embodiment, the instructions, when executed by the at least one processor (410, 2120) individually or collectively, may cause the electronic device (400, 401, 810, 1001, and 2101) to determine, based on the target SP having been determined, a change in a ratio of a partial bandwidth to the maximum bandwidth supported by the electronic device (400, 401, 810, 1001, and 2101). The instructions, when executed by the at least one processor (410, 2120) individually or collectively, may cause the electronic device (400, 401, 810, 1001, and 2101) to modify the first information based on the change in the ratio. The instructions, when executed by the at least one processor (410, 2120) individually or collectively, may cause the electronic device (400, 401, 810, 1001, and 2101) to transmit, to the AP (910, 1002), a second request frame including the modified first information. The instructions, when executed by the at least one processor (410, 2120) individually or collectively, may cause the electronic device (400, 401, 810, 1001, and 2101) to receive, from the AP (910, 1002), a second response frame corresponding to the second request frame. The instructions, when executed by the at least one processor (410, 2120) individually or collectively, may cause the electronic device (400, 401, 810, 1001, and 2101) to renegotiate the target SP with the AP (910, 1002) based on at least one of the second request frame or the second response frame.

According to an embodiment, the instructions, when executed by the at least one processor (410, 2120) individually or collectively, may cause the electronic device (400, 401, 810, 1001, and 2101) to broadcast, to one or more external electronic devices included in the first BSS, the information on the target SP as part of a frame.

According to an embodiment, the frame may include at least one of a beacon frame or a channel switching announcement (CSA) frame.

According to an embodiment, an operating method of an electronic device (e.g., the AP 401 of FIG. 3, the electronic device 400 of FIG. 4, the AP 810 of FIG. 8A, the first AP 1001 of FIG. 10, and/or the electronic device 2101 of FIG. 21) may include transmitting, to an AP (910, 1002), a first request frame requesting communication via a first secondary channel. The operating method may include receiving, from the AP (910, 1002), a first response frame requesting communication via a second secondary channel. The operating method may include performing negotiation with the AP (910, 1002) based on at least one of the first information or the second information to determine a target SP that is common in the first BSS and the second BSS. The operating method may include broadcasting information on the target SP to the first BSS. The first request frame may include first information on a first service period (SP). The first response frame may include second information on a second SP. A first primary channel of a first BSS formed by the electronic device (400, 401, 810, 1001, and 2101) may at least partially overlap a second primary channel of a second BSS formed by the the AP (910, 1002).

According to an embodiment, the first information may include information on the first secondary channel, a start time of the first SP, an interval of the first SP, and a duration of the first SP. The second information may include information on the second secondary channel, a start time of the second SP, an interval of the second SP, and a duration of the second SP.

According to an embodiment, each of the information on the first secondary channel and the information on the second secondary channel may include an identification number of a channel and the maximum bandwidth of the channel.

According to an embodiment, the transmitting of the first request frame may include determining a ratio of a partial bandwidth to the maximum bandwidth supported by the electronic device (400, 401, 810, 1001, and 2101). The transmitting of the first request frame may include triggering transmission of the first request frame based on the ratio. The partial bandwidth may be a portion of the maximum bandwidth that is in use.

According to an embodiment, the transmitting of the first request frame may include generating the first information based on a ratio of a partial bandwidth to the maximum bandwidth supported by the electronic device (400, 401, 810, 1001, and 2101). The partial bandwidth may be a portion of the maximum bandwidth that is in use.

According to an embodiment, the determining of the target SP may include determining, as the target SP, a SP having a greater duty cycle from the first SP and the second SP.

According to an embodiment, the operating method may include, determining, based on the target SP having been determined, a change in a ratio of a partial bandwidth to maximum bandwidth supported by the electronic device (400, 401, 810, 1001, and 2101). The operating method may include modifying the first information based on the change in the ratio. The operating method may include transmitting, to the AP (910, 1002), a second request frame including the modified first information. The operating method may include receiving, from the AP (910, 1002), a second response frame corresponding to the second request frame. The operating method may include renegotiating the target SP with the AP (910, 1002) based on at least one of the second request frame or the second response frame.

According to an embodiment, the broadcasting of the information on the target SP may include broadcasting, to one or more external electronic devices included in the first BSS, the information on the target SP as part of a frame.

According to an embodiment, the frame may include at least one of a beacon frame or a CSA frame.

According to an embodiment, an electronic device (e.g., the AP 401 of FIG. 3, the electronic device 400 of FIG. 4, the first AP 810 of FIG. 8A, the first AP 1001 of FIG. 10, and/or the first electronic device 2101 of FIG. 21) may include wireless communication circuitry (490, 2190). The electronic device (400, 401, 810, 1001, and 2101) may include at least one processor (e.g., the processor 410 of FIG. 4 and/or the processor 2120 of FIG. 21) including processing circuitry. The electronic device (400, 401, 810, 1001, and 2101) may include memory (e.g., the memory 420 of FIG. 4 and/or the memory 2130 of FIG. 21) storing instructions. The instructions, when executed by the at least one processor (410, 2120) individually or collectively, may cause the electronic device (400, 401, 810, 1001, and 2101) to provide, using the wireless communication circuitry (490, 2190), network access to one or more wireless communication devices via a primary channel of a first basic service set (BSS). The instructions, when executed by the at least one processor (410, 2120) individually or collectively, may cause the electronic device (400, 401, 810, 1001, and 2101) to generate first information on one or more first secondary channels corresponding to the first BSS and second information on a first SP based on a first request to use the one or more first secondary channels in the first BSS. The instructions, when executed by the at least one processor (410, 2120) individually or collectively, may cause the electronic device (400, 401, 810, 1001, and 2101) to obtain, using the wireless communication circuitry (490, 2190), third information on one or more second secondary channels corresponding to a second BSS and fourth information on a second SP based on a second request to use the one or more second secondary channels in the second BSS, from at least one of an external AP included in the second BSS or another device coupled with the external AP. The instructions, when executed by the at least one processor (410, 2120) individually or collectively, may cause the electronic device (400, 401, 810, 1001, and 2101) to determine at least a first portion of one of the one or more first secondary channels as a third secondary channel and at least a second portion of the first SP as a third SP based on at least in part on the first information, the second information, the third information, or the fourth information. The instructions, when executed by the at least one processor (410, 2120) individually or collectively, may cause the electronic device (400, 401, 810, 1001, and 2101) to provide the network access via the third secondary channel and prevent the network access via the primary channel during the third SP. The first BSS may comprise the electronic device (400, 401, 810, 1001, and 2101) and the one or more wireless communication devices.

According to an embodiment, the instructions, when executed by the at least one processor (410, 2120) individually or collectively, may cause the electronic device (400, 401, 810, 1001, and 2101) to broadcast, as part of at least one of a beacon frame or a CSA frame, fifth information on the third secondary channel and sixth information on the third SP via the primary channel instructing the one or more wireless communication devices to perform the network access via the third secondary channel during the third SP.

According to an embodiment, the instructions, when executed by the at least one processor (410, 2120) individually or collectively, may cause the electronic device (400, 401, 810, 1001, and 2101) to broadcast the first information and the second information as part of a beacon frame.

According to an embodiment, the instructions, when executed by the at least one processor (410, 2120) individually or collectively, may cause the electronic device (400, 401, 810, 1001, and 2101) to transmit, to at least one of the external AP or the another device, the first information and the second information as part of at least one of a negotiation request frame or a negotiation response frame. The negotiation request frame and the negotiation response frame may be associated with the primary channel.

According to an embodiment, another primary channel of the second BSS may be substantially identical to or at least partially overlap the primary channel of the first BSS.

According to an embodiment, the instructions, when executed by the at least one processor (410, 2120) individually or collectively, may cause the electronic device (400, 401, 810, 1001, and 2101) to determine that, based on the third SP at least partially overlapping a fourth SP of the second BSS, the third secondary channel does not overlap a fourth secondary channel of the second BSS.

According to an embodiment, the instructions, when executed by the at least one processor (410, 2120) individually or collectively, may cause the electronic device (400, 401, 810, 1001, and 2101) to determine that, based on the third secondary channel at least partially overlapping a fourth secondary channel of the second BSS, the third SP does not overlap a fourth SP of the second BSS.

According to an embodiment, the instructions, when executed by the at least one processor (410, 2120) individually or collectively, may cause the electronic device (400, 401, 810, 1001, and 2101) to comprise, as at least a portion of the first information, one or more first index numbers corresponding to the one or more first secondary channels, respectively, and a first maximum bandwidth capable of being provided via the one or more first secondary channels. According to an embodiment, the instructions, when executed by the at least one processor (410, 2120) individually or collectively, may cause the electronic device (400, 401, 810, 1001, and 2101) to comprise, as at least a portion of the third information, one or more second index numbers corresponding to the one or more second secondary channels, respectively, and a second maximum bandwidth capable of being provided via the one or more second secondary channels.

According to an embodiment, the instructions, when executed by the at least one processor (410, 2120) individually or collectively, may cause the electronic device (400, 401, 810, 1001, and 2101) to comprise, as at least a portion of the second information, a first start time, a first repetition interval, and a first duration of the first SP. The instructions, when executed by the at least one processor (410, 2120) individually or collectively, may cause the electronic device (400, 401, 810, 1001, and 2101) to comprise, as at least a portion of the fourth information, a second start time, a second repetition interval, and a second duration of the second SP.

According to an embodiment, the instructions, when executed by the at least one processor (410, 2120) individually or collectively, may cause the electronic device (400, 401, 810, 1001, and 2101) to request, based on the third secondary channel and the third SP being determined, coordination of the third SP to the at least one of the external AP or the another device such that at least one of a repetition interval of the third SP decreases or a duration of the third SP increases, based on at least one of a link state of at least one of the one or more wireless communication devices, a number of the one or more wireless communication devices, and a bandwidth corresponding to each of the one or more wireless communication devices.

According to an embodiment, the instructions, when executed by the at least one processor (410, 2120) individually or collectively, may cause the electronic device (400, 401, 810, 1001, and 2101) to, based on the third secondary channel and the third SP being determined, obtain, from at least one of a second external AP or the another device of a third BSS, seventh information on one or more fifth secondary channels corresponding to the third BSS and eighth information on a fifth SP based on a third request to use one or more fourth secondary channels in the third BSS. The instructions, when executed by the at least one processor (410, 2120) individually or collectively, may cause the electronic device (400, 401, 810, 1001, and 2101) to coordinate at least one of the third secondary channel or the third SP based at least in part on fifth information on the third secondary channel, sixth information on the third SP, the seventh information on the one or more fifth secondary channels, and the eighth information on the fifth SP.

According to an embodiment, the instructions, when executed by the at least one processor (410, 2120) individually or collectively, may cause the electronic device (400, 401, 810, 1001, and 2101) to determine whether a utilization ratio of a partial bandwidth, which is a portion of the maximum bandwidth of the first BSS, exceeds a threshold value when another primary channel of the second BSS is substantially the same as the primary channel of the first BSS. The instructions, when executed by the at least one processor (410, 2120) individually or collectively, may cause the electronic device (400, 401, 810, 1001, and 2101) to perform the determination of the third secondary channel and the third SP based at least in part on the utilization ratio of the partial bandwidth exceeding the threshold value.

The electronic device, according to various embodiments, may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as "A or B," "at least one of A and B," "at least one of A or B," "A, B, or C," "at least one of A, B, and C," and "at least one of A, B, or C," may include any one of, or all possible combinations of the items enumerated together in a corresponding one of the phrases. As used herein, such terms as "1st" and "2nd," or "first" and "second" may be used to simply distinguish a corresponding component from another, and does not limit the components in other aspect (e.g., importance or order). It is to be understood that if an element (e.g., a first element) is referred to, with or without the term "operatively" or "communicatively", as "coupled with," "coupled to," "connected with," or "connected to" another element (e.g., a second element), it means that the element may be coupled with the other element directly (e.g., wiredly), wirelessly, or via a third element.

As used in connection with various embodiments of the disclosure, the term "module" may include a unit implemented in hardware, software, or firmware, and may interchangeably be used with other terms, for example, "logic," "logic block," "part," or "circuitry". A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 2140) including one or more instructions that are stored in a storage medium (e.g., internal memory 2136 or external memory 2138) that is readable by a machine (e.g., the first electronic device 2101). For example, a processor (e.g., the processor 2120) of the machine (e.g., the first electronic device 2101) may invoke at least one of the one or more instructions stored in the storage medium, and execute it, with or without using one or more other components under the control of the processor. This allows the machine to be operated to perform at least one function according to the at least one instruction invoked. The one or more instructions may include code generated by a complier or code executable by an interpreter. The machine-readable storage medium may be provided in the form of a non-transitory storage medium. Wherein, the term "non-transitory" simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

What is claimed is:

1. An electronic device, comprising:
wireless communication circuitry,
at least one processor comprising processing circuitry, and
memory storing instructions that, when executed by the at least one processor individually or collectively, cause the electronic device to:
transmit to an access point (AP), through the wireless communication circuitry, a first request frame requesting communication via a first secondary channel, the first request frame comprising first information on a first service period (SP), a first primary channel of a first basic service set (BSS) formed by the electronic device at least partially overlapping a second primary channel of a second BSS formed by the AP,
receive from the AP, through the wireless communication circuitry, a first response frame requesting communication via a second secondary channel, the first response frame comprising second information on a second SP,
perform negotiation with the AP, based on at least one of the first information or the second information, to determine a target SP that is common in the first BSS and the second BSS, and
broadcast information on the target SP to the first BSS.

2. The electronic device of claim 1, wherein the first information comprises information on the first secondary channel, a start time of the first SP, an interval of the first SP, and a duration of the first SP, and
wherein the second information comprises information on the second secondary channel, a start time of the second SP, an interval of the second SP, and a duration of the second SP.

3. The electronic device of claim 2, wherein each of the information on the first secondary channel and the information on the second secondary channel comprises an identification number of a channel and a maximum bandwidth of the channel.

4. The electronic device of claim 1, wherein the instructions, when executed by the at least one processor individually or collectively, further cause the electronic device to:
determine a ratio of a partial bandwidth to a maximum bandwidth supported by the electronic device, the partial bandwidth being a portion of the maximum bandwidth that is in use, and
trigger transmission of the first request frame based on the ratio.

5. The electronic device of claim 1, wherein the instructions, when executed by the at least one processor individually or collectively, further cause the electronic device to generate the first information based on a ratio of a partial bandwidth to a maximum bandwidth supported by the electronic device, the partial bandwidth being a portion of the maximum bandwidth that is in use.

6. The electronic device of claim 1, wherein the instructions, when executed by the at least one processor individually or collectively, further cause the electronic device to:
determine, as the target SP, a SP having a greater duty cycle from the first SP and the second SP.

7. The electronic device of claim 1, wherein the instructions, when executed by the at least one processor individually or collectively, further cause the electronic device to:
determine, based on the target SP having been determined, a change in a ratio of a partial bandwidth to a maximum bandwidth supported by the electronic device, the partial bandwidth being a portion of the maximum bandwidth that is in use in the first BSS,
modify the first information based on the change in the ratio,
transmit, to the AP, a second request frame comprising the modified first information,
receive, from the AP, a second response frame corresponding to the second request frame, and
renegotiate the target SP with the AP based on at least one of the second request frame or the second response frame.

8. The electronic device of claim 1, wherein the instructions, when executed by the at least one processor individually or collectively, further cause the electronic device to broadcast, to one or more external electronic devices comprised in the first BSS, the information on the target SP as part of a frame.

9. The electronic device of claim 8, wherein the frame comprises at least one of a beacon frame or a channel switching announcement (CSA) frame.

10. An electronic device, comprising:
wireless communication circuitry,
at least one processor comprising processing circuitry, and
memory storing instructions that, when executed by the at least one processor individually or collectively, cause the electronic device to:
provide, using the wireless communication circuitry, network access to one or more wireless communication devices via a primary channel of a first basic service set (BSS), the first BSS comprising the electronic device and the one or more wireless communication devices,
generate first information on one or more first secondary channels corresponding to the first BSS and second information on a first service period (SP) based on a first request to use the one or more first secondary channels in the first BSS,
obtain, using the wireless communication circuitry, third information on one or more second secondary channels corresponding to a second BSS and fourth information on a second SP based on a second request to use the one or more second secondary channels in the second BSS, from at least one of an external access point (AP) comprised in the second BSS or another device coupled with the external AP,
determine at least a first portion of one of the one or more first secondary channels as a third secondary channel and at least a second portion of the first SP as a third SP, based on at least in part on the first information, the second information, the third information, or the fourth information, and
provide the network access via the third secondary channel and prevent the network access via the primary channel during the third SP.

11. The electronic device of claim 10, wherein the instructions, when executed by the at least one processor individually or collectively, further cause the electronic device to broadcast, as part of at least one of a beacon frame or a channel switching announcement (CSA) frame, fifth information on the third secondary channel and sixth information on the third SP via the primary channel instructing the one or more wireless communication devices to perform the network access via the third secondary channel during the third SP.

12. The electronic device of claim 10, wherein the instructions, when executed by the at least one processor individually or collectively, further cause the electronic device to broadcast the first information and the second information as part of a beacon frame.

13. The electronic device of claim 10, wherein the instructions, when executed by the at least one processor individually or collectively, further cause the electronic device to transmit, to at least one of the external AP or the another device, the first information and the second information as part of at least one of a negotiation request frame or a negotiation response frame, the negotiation request frame and the negotiation response frame being associated with the primary channel.

14. The electronic device of claim 10, wherein another primary channel of the second BSS at least partially overlaps the primary channel of the first BSS.

15. The electronic device of claim 10, wherein the instructions, when executed by the at least one processor individually or collectively, further cause the electronic device to determine that, based on the third SP at least partially overlapping a fourth SP of the second BSS, the third secondary channel does not overlap a fourth secondary channel of the second BSS.

16. The electronic device of claim 10, wherein the instructions, when executed by the at least one processor individually or collectively, further cause the electronic device to determine that, based on the third secondary channel at least partially overlapping a fourth secondary channel of the second BSS, the third SP does not overlap a fourth SP of the second BSS.

17. The electronic device of claim 10, wherein the instructions, when executed by the at least one processor individually or collectively, further cause the electronic device to:
comprise, as at least a portion of the first information, one or more first index numbers corresponding to the one or more first secondary channels, respectively, and a first maximum bandwidth capable of being provided via the one or more first secondary channels, and
comprise, as at least a portion of the third information, one or more second index numbers corresponding to the one or more second secondary channels, respectively, and a second maximum bandwidth capable of being provided via the one or more second secondary channels.

18. The electronic device of claim 10, wherein the instructions, when executed by the at least one processor individually or collectively, further cause the electronic device to:
comprise, as at least a portion of the second information, a first start time, a first repetition interval, and a first duration of the first SP, and
comprise, as at least a portion of the fourth information, a second start time, a second repetition interval, and a second duration of the second SP.

19. The electronic device of claim 10, wherein the instructions, when executed by the at least one processor individually or collectively, further cause the electronic device to request, based on the third secondary channel and the third SP being determined, coordination of the third SP to the at least one of the external AP or the another device such that at least one of a repetition interval of the third SP decreases or a duration of the third SP increases, based on at least one of a link state of at least one of the one or more wireless communication devices, a number of the one or more wireless communication devices, and a bandwidth corresponding to each of the one or more wireless communication devices.

20. The electronic device of claim 10, wherein the instructions, when executed by the at least one processor individually or collectively, further cause the electronic device to:
based on the third secondary channel and the third SP being determined, obtain, from at least one of a second external AP or the another device of a third BSS, seventh information on one or more fifth secondary channels corresponding to the third BSS and eighth information on a fifth SP based on a third request to use one or more fourth secondary channels in the third BSS, and
coordinate at least one of the third secondary channel or the third SP based at least in part on fifth information on the third secondary channel, sixth information on the third SP, the seventh information on the one or more fifth secondary channels, and the eighth information on the fifth SP.
